(19) United States
(12) Patent Application Publication
(10) Pub. No.: US 2024/0005685 A1
(43) Pub. Date: Jan. 4, 2024

(54) GEOSPATIAL IMAGE DATA PROCESSING TO DETECT NODES AND INTERCONNECTIONS

(71) Applicant: SparkCognition, Inc., Austin, TX (US)

(72) Inventors: Elad Liebman, Austin, TX (US); Imroze Aslam, Lahore (PK)

(21) Appl. No.: 18/344,848

(22) Filed: Jun. 29, 2023

Related U.S. Application Data
(60) Provisional application No. 63/367,231, filed on Jun. 29, 2022.

(51) Int. Cl. G06V 30/18; G06T 7/13; G06T 7/60; G06V 10/25; G06V 30/19

(52) U.S. Cl. CPC G06V 30/18076; G06T 7/13; G06T 7/60; G06V 10/25; G06V 30/19173; G06V 2201/07

(57) ABSTRACT

A device includes one or more processors configured to access a raster image representing geospatial data of a geographical region. The one or more processors are also configured to process the raster image based on application of at least one machine learning model to generate output data corresponding to a vector image that corresponds to at least a portion of the geographical region.

### CROSS-REFERENCE TO RELATED APPLICATION

The present application claims priority from U.S. Provisional Patent Application No. 63/367,231 filed Jun. 29, 2022, the content of which is incorporated by reference herein in its entirety.

### FIELD

The present disclosure is generally related to processing geospatial image data to detect nodes and interconnections.

### BACKGROUND

Images, such as drawings or photographs, of geographical regions include useful information. For example, scanned images of manually drawn maps of gas pipelines can indicate visual and geographical information, as well as text annotations. Extracting the information in a digitized logical form can be useful for searching and analysis.

### SUMMARY

The present disclosure describes systems and methods that enable processing geospatial image data to detect nodes and interconnections. For example, an image of a manually drawn map of gas pipelines can be processed to detect polygons corresponding to houses and lines corresponding to gas service lines. Output data is generated, based on the polygons and lines, that indicates the houses and the gas service lines. Text annotations associated with the houses and text annotations associated with the gas service lines can also be detected and included in the output data. Houses and gas service lines are used as an illustrative example. In other examples, an image representing geospatial data of a geographical region can be processed to detect polygons corresponding to nodes of the geographical region and lines corresponding to interconnections between at least some of the nodes. To illustrate, non-limiting examples of nodes can include houses, buildings, other human-made structures, natural structures, fixed position nodes, movable nodes, or a combination thereof. Non-limiting examples of interconnections can include gas lines, electric lines, water lines, other types of utility lines, roads, streets, walkways, or a combination thereof.

In some aspects, a device includes one or more processors configured to access a raster image representing geospatial data of a geographical region. The one or more processors are also configured to process the raster image based on application of at least one machine learning model to generate output data corresponding to a vector image that corresponds to at least a portion of the geographical region.

In some aspects, a device includes one or more processors configured to access an image representing geospatial data of a geographical region. The one or more processors are also configured to process the image to detect polygons. Each polygon of the polygons represents a respective node of a plurality of nodes of the geographical region. The one or more processors are further configured to process the image to detect lines. A particular line of the lines represents a particular interconnection between a particular node of the plurality of nodes and one or more other nodes of the plurality of nodes. The one or more processors are also configured to generate, based on the polygons and the lines, output data indicating the plurality of nodes and interconnections between at least some of the plurality of nodes.

In some aspects, a method includes accessing, at a device, an image representing geospatial data of a geographical region. The method also includes processing, at the device, the image to detect polygons. Each polygon of the polygons represents a respective node of a plurality of nodes of the geographical region. The method further includes processing, at the device, the image to detect lines. A particular line of the lines represents a particular interconnection between a particular node of the plurality of nodes and one or more other nodes of the plurality of nodes. The method also includes generating, based on the polygons and the lines, output data indicating the plurality of nodes and interconnections between at least some of the plurality of nodes.

In some aspects, a computer-readable medium stores instructions that, when executed by one or more processors, cause the one or more processors to access an image representing geospatial data of a geographical region. The instructions, when executed by the one or more processors, also cause the one or more processors to process the image to detect polygons. Each polygon of the polygons represents a particular node of a plurality of nodes of the geographical region. The instructions, when executed by the one or more processors, further cause the one or more processors to process the image to detect lines. A particular line of the lines represents a particular interconnection between a particular node of the plurality of nodes and one or more other nodes of the plurality of nodes. The instructions, when executed by the one or more processors, also cause the one or more processors to generate, based on the polygons and the lines, output data indicating the plurality of nodes and interconnections between at least some of the plurality of nodes.

### BRIEF DESCRIPTION OF THE DRAWINGS

FIG. 1 is a block diagram illustrating a particular implementation of a system that may process geospatial image data to detect nodes and interconnections.

FIG. 2 is a diagram illustrating one, non-limiting, example of operations associated with text contour detection that may be performed by the system of FIG. 1 in accordance with some examples of the present disclosure.

FIG. 3 is a diagram illustrating one, non-limiting, example of operations associated with main line segmentation that may be performed by the system of FIG. 1 in accordance with some examples of the present disclosure.

FIG. 4 is a diagram illustrating one, non-limiting, example of operations associated with optical character recognition (OCR) that may be performed by the system of FIG. 1 in accordance with some examples of the present disclosure.

FIG. 5 is a diagram illustrating one, non-limiting, example of operations associated with text contour classification that may be performed by the system of FIG. 1 in accordance with some examples of the present disclosure.

FIG. 6 is a diagram illustrating one, non-limiting, example of operations associated with line detection and ranking that may be performed by the system of FIG. 1 in accordance with some examples of the present disclosure.

FIG. 7 is a diagram illustrating one, non-limiting, example of operations associated with service line path finding that may be performed by the system of FIG. 1 in accordance with some examples of the present disclosure.

FIG. 8 is a diagram illustrating one, non-limiting, example of operations associated with house boundary estimation that may be performed by the system of FIG. 1 in accordance with some examples of the present disclosure.

FIG. 9 is a diagram illustrating one, non-limiting, example of operations associated with pixel-level segmentation that may be performed by the system of FIG. 1 in accordance with some examples of the present disclosure.

FIG. 10 is a diagram illustrating one, non-limiting, example of operations associated with geospatial projection that may be performed by the system of FIG. 1 in accordance with some examples of the present disclosure.

FIG. 11 is a diagram illustrating one, non-limiting, example of operations associated with output generation that may be performed by the system of FIG. 1 in accordance with some examples of the present disclosure.

FIG. 12 is a flow chart of an example of a method in accordance with some examples of the present disclosure.

### DETAILED DESCRIPTION

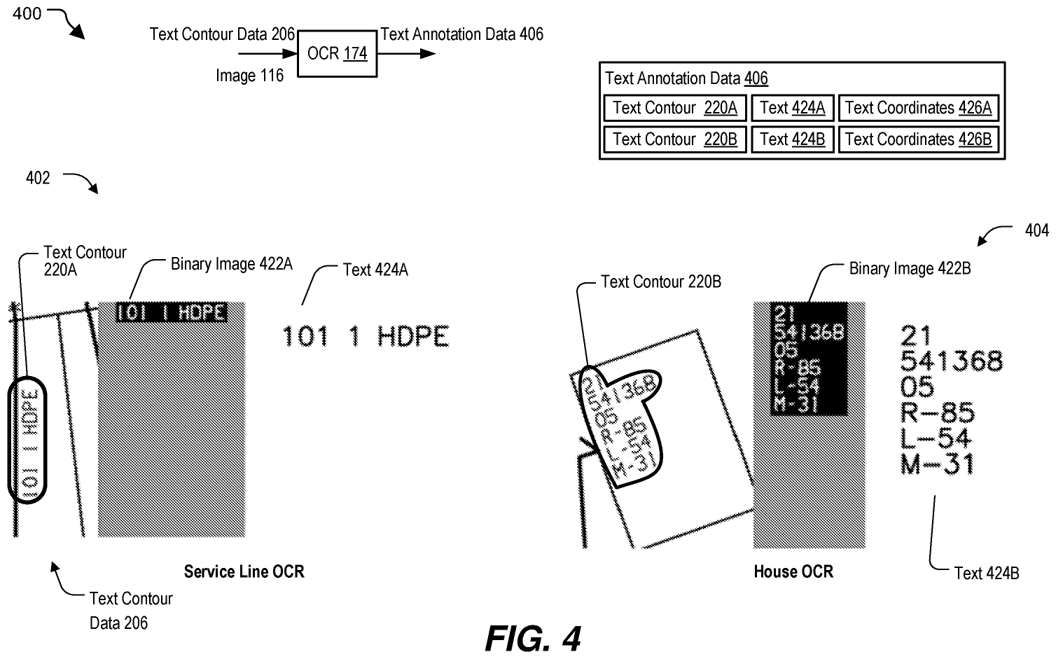

Particular aspects of the present disclosure are described below with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 4, multiple text contours are illustrated and associated with reference numbers 220A and 220B. When referring to a particular one of these text contours, such as the text contour 220A, the distinguishing letter “A” is used. However, when referring to any arbitrary one of these text contours or to these text contours as a group, the reference number 220 is used without a distinguishing letter.

As used herein, various terminology is used for the purpose of describing particular implementations only and is not intended to be limiting. For example, the singular forms “a,” “an,” and “the” are intended to include the plural forms as well, unless the context clearly indicates otherwise. Further the terms “comprise,” “comprises,” and “comprising” may be used interchangeably with “include,” “includes,” or “including.” Additionally, the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. Such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

As used herein, the term “machine learning” should be understood to have any of its usual and customary meanings within the fields of computer science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so-called “transfer learning.” As described further below, in transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Machine-learning models can be initialized from scratch (e.g., by a user, such as a data scientist) or using a guided process (e.g., using a template or previously built model). Initializing the model includes specifying parameters and hyperparameters of the model. “Hyperparameters” are characteristics of a model that are not modified during training, and “parameters” of the model are characteristics of the model that are modified during training. The term “hyperparameters” may also be used to refer to parameters of the training process itself, such as a learning rate of the training process. In some examples, the hyperparameters of the model are specified based on the task the model is being created for, such as the type of data the model is to use, the goal of the model (e.g., classification, regression, anomaly detection), etc. The hyperparameters may also be specified based on other design goals associated with the model, such as a memory footprint limit, where and when the model is to be used, etc.

Model type and model architecture of a model illustrate a distinction between model generation and model training. The model type of a model, the model architecture of the model, or both, can be specified by a user or can be automatically determined by a computing device. However, neither the model type nor the model architecture of a particular model is changed during training of the particular model. Thus, the model type and model architecture are hyperparameters of the model and specifying the model type and model architecture is an aspect of model generation (rather than an aspect of model training). In this context, a “model type” refers to the specific type or sub-type of the machine-learning model. As noted above, examples of machine-learning model types include, without limitation, perceptrons, neural networks, support vector machines, regression models, decision trees, Bayesian models, Boltzmann machines, adaptive neuro-fuzzy inference systems, as well as combinations, ensembles and variants of these and other types of models. In this context, “model architecture” (or simply “architecture”) refers to the number and arrangement of model components, such as nodes or layers, of a model, and which model components provide data to or receive data from other model components. As a non-limiting example, the architecture of a neural network may be specified in terms of nodes and links. To illustrate, a neural network architecture may specify the number of nodes in an input layer of the neural network, the number of hidden layers of the neural network, the number of nodes in each hidden layer, the number of nodes of an output layer, and which nodes are connected to other nodes (e.g., to provide input or receive output). As another non-limiting example, the architecture of a neural network may be specified in terms of layers. To illustrate, the neural network architecture may specify the number and arrangement of specific types of functional layers, such as long-short-term memory (LSTM) layers, fully connected (FC) layers, convolution layers, etc. While the architecture of a neural network implicitly or explicitly describes links between nodes or layers, the architecture does not specify link weights. Rather, link weights are parameters of a model (rather than hyperparameters of the model) and are modified during training of the model.

In many implementations, a data scientist selects the model type before training begins. However, in some implementations, a user may specify one or more goals (e.g., classification or regression), and automated tools may select one or more model types that are compatible with the specified goal(s). In such implementations, more than one model type may be selected, and one or more models of each selected model type can be generated and trained. A best performing model (based on specified criteria) can be selected from among the models representing the various model types. Note that in this process, no particular model type is specified in advance by the user, yet the models are trained according to their respective model types. Thus, the model type of any particular model does not change during training.

Similarly, in some implementations, the model architecture is specified in advance (e.g., by a data scientist); whereas in other implementations, a process that both generates and trains a model is used. Generating (or generating and training) the model using one or more machine-learning techniques is referred to herein as “automated model building”. In one example of automated model building, an initial set of candidate models is selected or generated, and then one or more of the candidate models are trained and evaluated. In some implementations, after one or more rounds of changing hyperparameters and/or parameters of the candidate model(s), one or more of the candidate models may be selected for deployment (e.g., for use in a runtime phase).

Certain aspects of an automated model building process may be defined in advance (e.g., based on user settings, default values, or heuristic analysis of a training data set) and other aspects of the automated model building process may be determined using a randomized process. For example, the architectures of one or more models of the initial set of models can be determined randomly within predefined limits. As another example, a termination condition may be specified by the user or based on configurations settings. The termination condition indicates when the automated model building process should stop. To illustrate, a termination condition may indicate a maximum number of iterations of the automated model building process, in which case the automated model building process stops when an iteration counter reaches a specified value. As another illustrative example, a termination condition may indicate that the automated model building process should stop when a reliability metric associated with a particular model satisfies a threshold. As yet another illustrative example, a termination condition may indicate that the automated model building process should stop if a metric that indicates improvement of one or more models over time (e.g., between iterations) satisfies a threshold. In some implementations, multiple termination conditions, such as an iteration count condition, a time limit condition, and a rate of improvement condition can be specified, and the automated model building process can stop when one or more of these conditions is satisfied.

Another example of training a previously generated model is transfer learning. “Transfer learning” refers to initializing a model for a particular data set using a model that was trained using a different data set. For example, a “general purpose” model can be trained to detect anomalies in vibration data associated with a variety of types of rotary equipment, and the general purpose model can be used as the starting point to train a model for one or more specific types of rotary equipment, such as a first model for generators and a second model for pumps. As another example, a general-purpose natural-language processing model can be trained using a large selection of natural-language text in one or more target languages. In this example, the general-purpose natural-language processing model can be used as a starting point to train one or more models for specific natural-language processing tasks, such as translation between two languages, question answering, or classifying the subject matter of documents. Often, transfer learning can converge to a useful model more quickly than building and training the model from scratch.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

As another example, to use supervised training to train a model to perform a classification task, each data element of a training data set may be labeled to indicate a category or categories to which the data element belongs. In this example, during the creation/training phase, data elements are input to the model being trained, and the model generates output indicating categories to which the model assigns the data elements. The category labels associated with the data elements are compared to the categories assigned by the model. The computer modifies the model until the model accurately and reliably (e.g., within some specified criteria) assigns the correct labels to the data elements. In this example, the model can subsequently be used (in a runtime phase) to receive unknown (e.g., unlabeled) data elements, and assign labels to the unknown data elements. In an unsupervised training scenario, the labels may be omitted. During the creation/training phase, model parameters may be tuned by the training algorithm in use such that during the runtime phase, the model is configured to determine which of multiple unlabeled “clusters” an input data sample is most likely to belong to.

As another example, to train a model to perform a regression task, during the creation/training phase, one or more data elements of the training data are input to the model being trained, and the model generates output indicating a predicted value of one or more other data elements of the training data. The predicted values of the training data are compared to corresponding actual values of the training data, and the computer modifies the model until the model accurately and reliably (e.g., within some specified criteria) predicts values of the training data. In this example, the model can subsequently be used (in a runtime phase) to receive data elements and predict values that have not been received. To illustrate, the model can analyze time series data, in which case, the model can predict one or more future values of the time series based on one or more prior values of the time series.

In some aspects, the output of a model can be subjected to further analysis operations to generate a desired result. To illustrate, in response to particular input data, a classification model (e.g., a model trained to perform classification tasks) may generate output including an array of classification scores, such as one score per classification category that the model is trained to assign. Each score is indicative of a likelihood (based on the model's analysis) that the particular input data should be assigned to the respective category. In this illustrative example, the output of the model may be subjected to a softmax operation to convert the output to a probability distribution indicating, for each category label, a probability that the input data should be assigned the corresponding label. In some implementations, the probability distribution may be further processed to generate a one-hot encoded array. In other examples, other operations that retain one or more category labels and a likelihood value associated with each of the one or more category labels can be used.

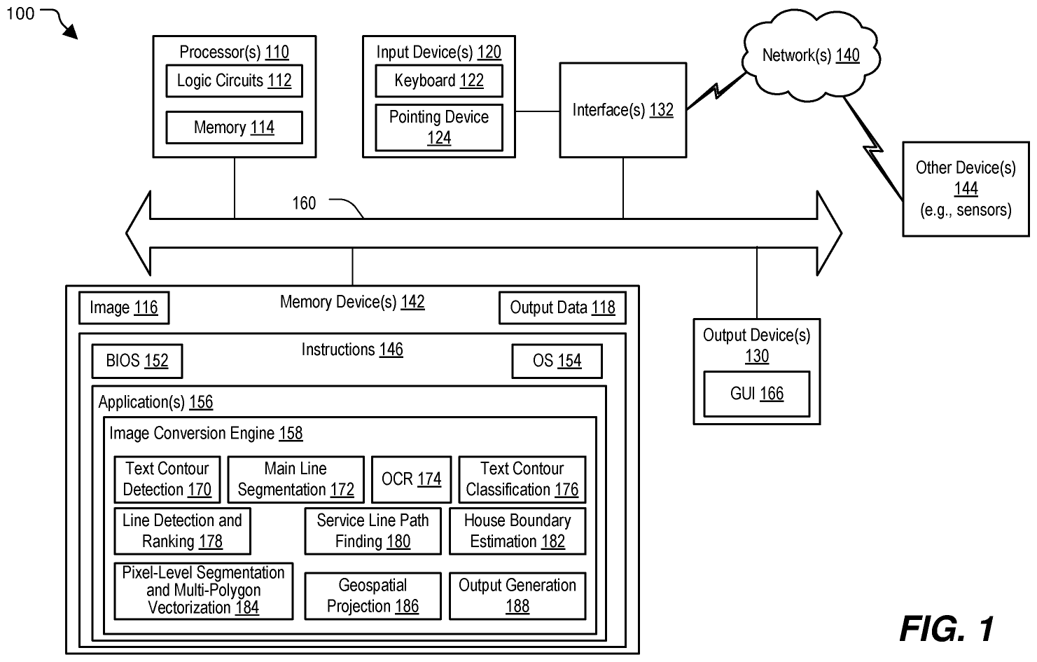

FIG. 1 illustrates an example of a system 100 that is configured to perform geospatial image data processing to detect nodes and interconnections. The system 100 can be implemented as or incorporated into one or more of various other devices, such as a personal computer (PC), a tablet PC, a server computer, a cloud-based computing system, a control system, an internet of things device, a personal digital assistant (PDA), a laptop computer, a desktop computer, a communications device, a wireless telephone, or any other machine capable of executing a set of instructions (sequential or otherwise) that specify actions to be taken by that machine. Further, while a single system 100 is illustrated, the term “system” includes any collection of systems or sub-systems that individually or jointly execute a set, or multiple sets, of instructions to perform one or more computer functions.

While FIG. 1 illustrates one example of the system 100, other computer systems or computing architectures and configurations may be used for carrying out the geospatial image data processing operations disclosed herein. The system 100 includes one or more processors 110. Each processor of the one or more processors 110 can include a single processing core or multiple processing cores that operate sequentially, in parallel, or sequentially at times and in parallel at other times. Each processor of the one or more processors 110 includes circuitry defining a plurality of logic circuits 112, working memory 114 (e.g., registers and cache memory), communication circuits, etc., which together enable the one or more processors 110 to control the operations performed by the system 100 and enable the one or more processors 110 to generate a useful result based on analysis of particular data and execution of specific instructions.

The one or more processors 110 are configured to interact with other components or subsystems of the system 100 via a bus 160. The bus 160 is illustrative of any interconnection scheme serving to link the subsystems of the system 100, external subsystems or devices, or any combination thereof. The bus 160 includes a plurality of conductors to facilitate communication of electrical and/or electromagnetic signals between the components or subsystems of the system 100. Additionally, the bus 160 includes one or more bus controllers or other circuits (e.g., transmitters and receivers) that manage signaling via the plurality of conductors and that cause signals sent via the plurality of conductors to conform to particular communication protocols.

In a particular aspect, dedicated hardware implementations, such as application specific integrated circuits, programmable logic arrays and other hardware devices, can be constructed to implement one or more of the operations described herein. Accordingly, the present disclosure encompasses software, firmware, and hardware implementations.

The system 100 also includes the one or more memory devices 142. The one or more memory devices 142 include any suitable computer-readable storage device depending on, for example, whether data access needs to be bi-directional or unidirectional, speed of data access required, memory capacity required, other factors related to data access, or any combination thereof. Generally, the one or more memory devices 142 includes some combinations of volatile memory devices and non-volatile memory devices, though in some implementations, only one or the other may be present. Examples of volatile memory devices and circuits include registers, caches, latches, many types of random-access memory (RAM), such as dynamic random-access memory (DRAM), etc. Examples of non-volatile memory devices and circuits include hard disks, optical disks, flash memory, and certain type of RAM, such as resistive random-access memory (ReRAM). Other examples of both volatile and non-volatile memory devices can be used as well, or in the alternative, so long as such memory devices store information in a physical, tangible medium. Thus, the one or more memory devices 142 include circuits and structures and are not merely signals or other transitory phenomena (i.e., are non-transitory media).

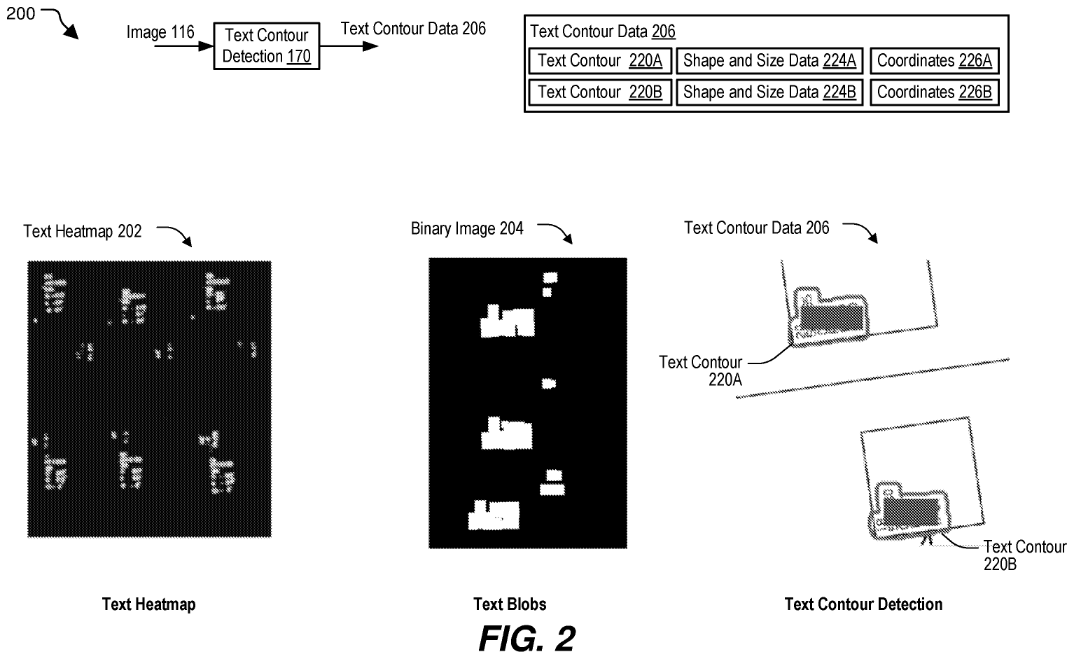

In the example illustrated in FIG. 1, the one or more memory devices 142 store the instructions 146 that are executable by the one or more processors 110 to perform various operations and functions. The instructions 146 include instructions to enable the various components and subsystems of the system 100 to operate, interact with one another, and interact with a user, such as a basic input/output system (BIOS) 152 and an operating system (OS) 154. Additionally, the instructions 146 include one or more applications 156, scripts, or other program code to enable the one or more processors 110 to perform the operations described herein. For example, in FIG. 1, the instructions 146 include an image conversion engine 158 that is configured to process geospatial data (e.g., an image 116) of a geographical region to detect nodes and interconnections of the geographical region, and to generate output data 118 indicating the nodes and interconnections, as further described with reference to FIGS. 2-10.

In FIG. 1, the system 100 also includes one or more output devices 130, one or more input devices 120, and one or more interface devices 132. Each of the one or more output devices 130, the one or more input devices 120, and the one or more interface devices 132 can be coupled to the bus 160 via a port or connector, such as a Universal Serial Bus port, a digital visual interface (DVI) port, a serial ATA (SATA) port, a small computer system interface (SCSI) port, a high-definition media interface (HDMI) port, or another serial or parallel port. In some implementations, one or more of the one or more output devices 130, the one or more input devices 120, the one or more interface devices 132 is coupled to or integrated within a housing with the one or more processors 110 and the one or more memory devices 142, in which case the connections to the bus 160 can be internal, such as via an expansion slot or other card-to-card connector. In other implementations, the one or more processors 110 and the one or more memory devices 142 are integrated within a housing that includes one or more external ports, and one or more of the one or more output devices 130, the one or more input devices 120, the one or more interface devices 132 is coupled to the bus 160 via the one or more external ports.

Examples of the one or more output devices 130 include display devices, speakers, printers, televisions, projectors, or other devices to provide output of data in a manner that is perceptible by a user. Examples of the one or more input devices 120 include buttons, switches, knobs, a keyboard 122, a pointing device 124, a biometric device, a microphone, a motion sensor, or another device to detect user input actions. The pointing device 124 includes, for example, one or more of a mouse, a stylus, a track ball, a pen, a touch pad, a touch screen, a tablet, another device that is useful for interacting with a graphical user interface, or any combination thereof. A particular device may be an input device 120 and an output device 130. For example, the particular device may be a touch screen.

The one or more interface devices 132 are configured to enable the system 100 to communicate with one or more other devices 144 directly or via one or more networks 140. For example, the one or more interface devices 132 may encode data in electrical and/or electromagnetic signals that are transmitted to the one or more other devices 144 as control signals or packet-based communication using pre-defined communication protocols. As another example, the one or more interface devices 132 may receive and decode electrical and/or electromagnetic signals that are transmitted by the one or more other devices 144. The electrical and/or electromagnetic signals can be transmitted wirelessly (e.g., via propagation through free space), via one or more wires, cables, optical fibers, or via a combination of wired and wireless transmission.

During operation, the image conversion engine 158 obtains geospatial data of a geographical region. For example, the image conversion engine 158 accesses an image 116 representing geospatial data of the geographical region. To illustrate, the image 116 can include a hand-drawn image, a photograph, or both, representing the geographical region.

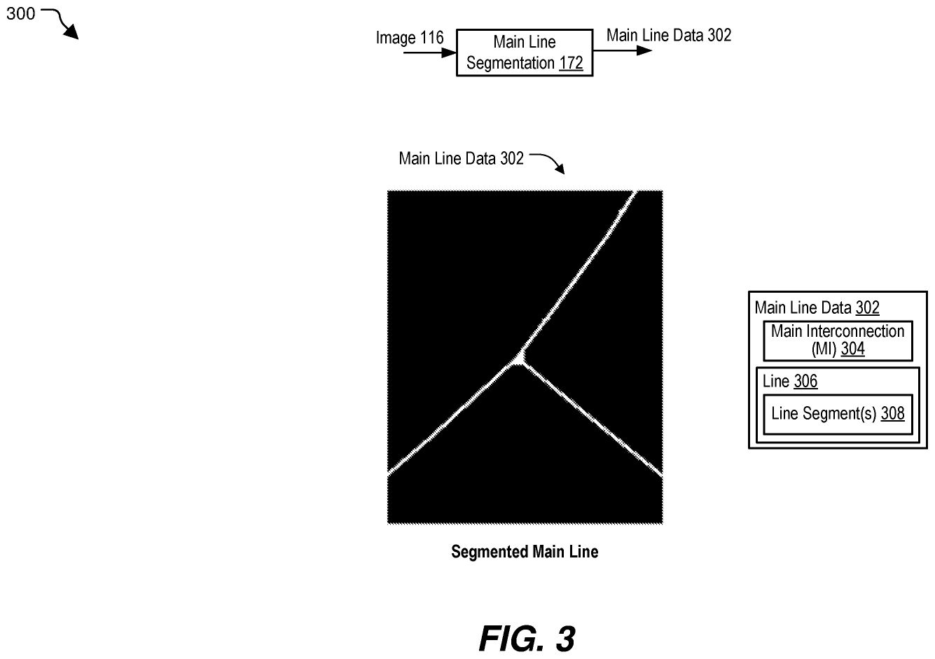

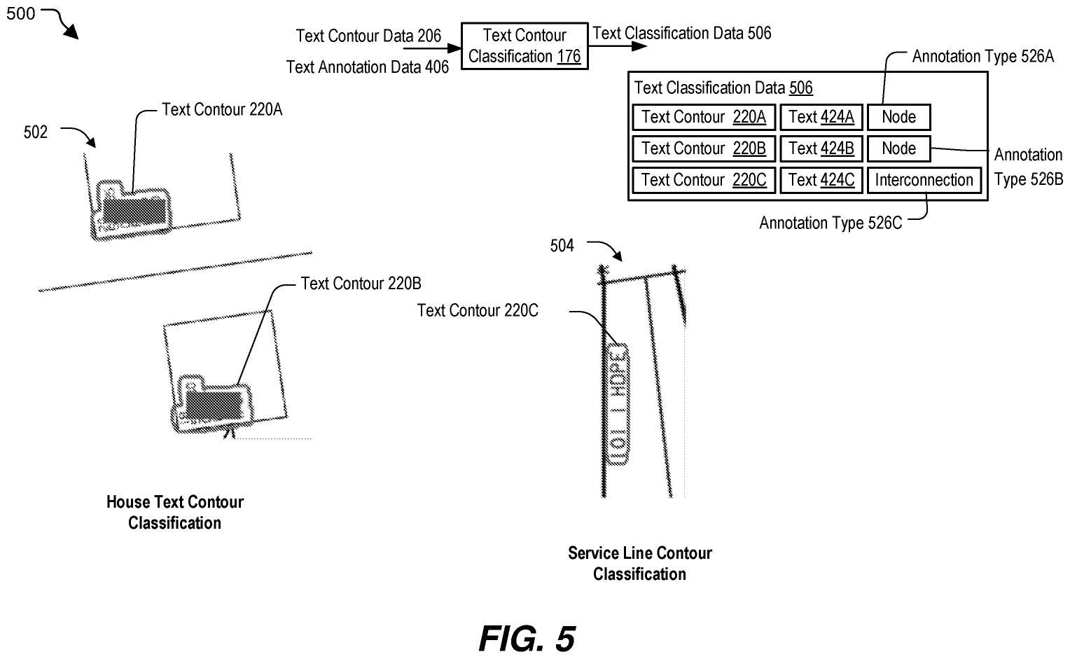

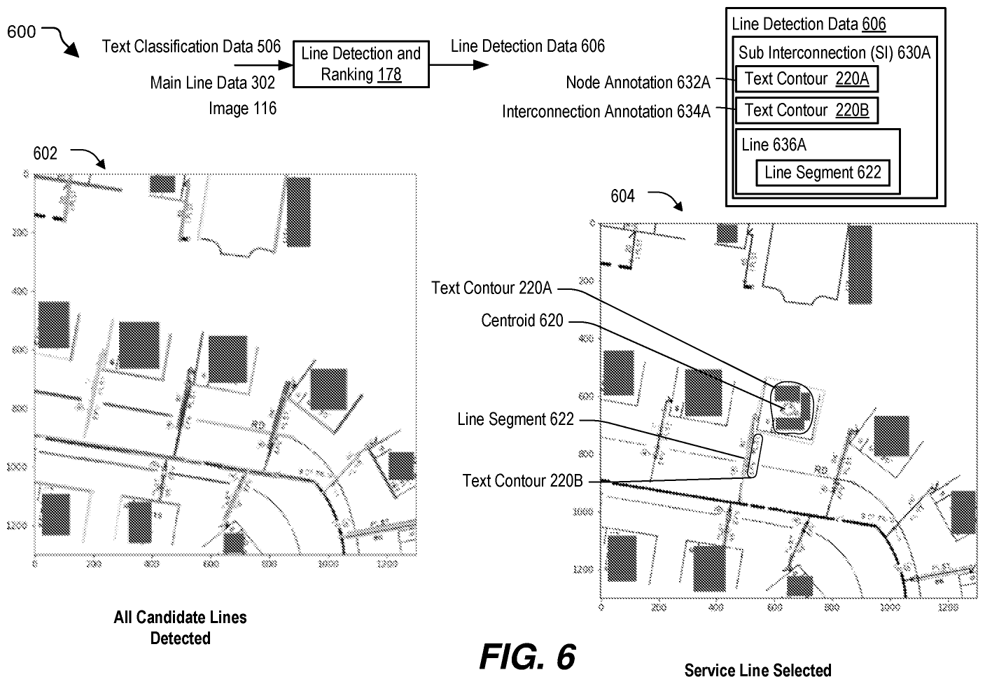

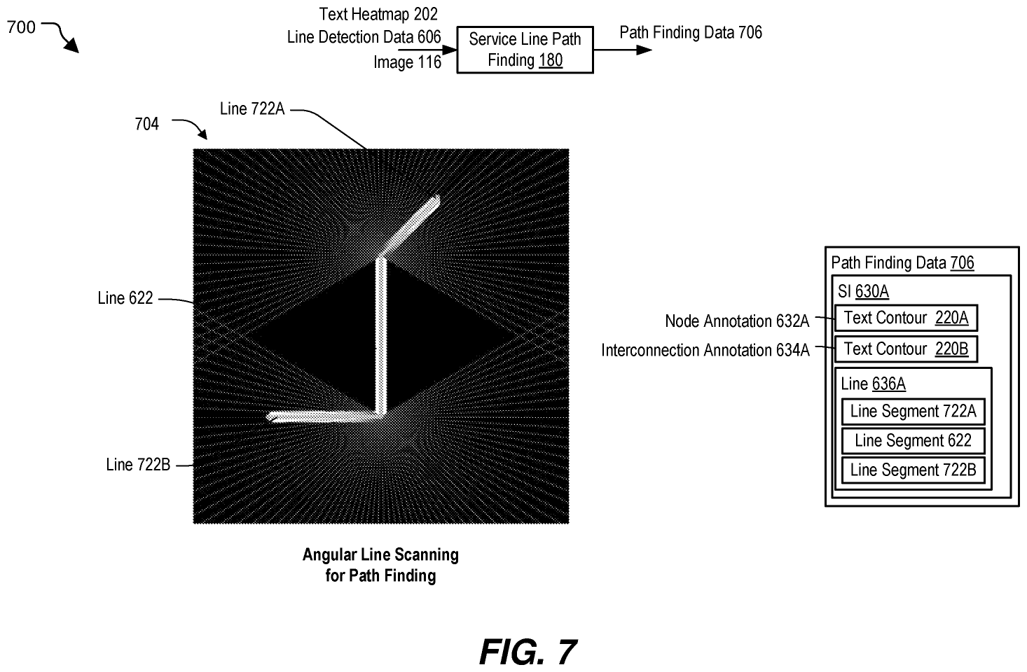

In a particular aspect, the image conversion engine 158 performs text contour detection 170 to detect contours of text annotations represented in the image 116, as further described with reference to FIG. 2. In a particular aspect, the image conversion engine 158 performs main line segmentation 172 to detect main lines (e.g., a main interconnection) represented in the image 116, as further described with reference to FIG. 3. In a particular aspect, the image conversion engine 158 performs optical character recognition (OCR) 174 to detect characters (e.g., letters, digits, other characters, etc.) of the text in the image 116, as further described with reference to FIG. 4. In a particular aspect, the image conversion engine 158 performs text contour classification 176 to classify the contours of the text annotations as associated with a node or an interconnection, as further described with reference to FIG. 5. In a particular aspect, the image conversion engine 158 performs line detection and ranking 178 to identify service lines (e.g., sub interconnections), as further described with reference to FIG. 6. In a particular aspect, the image conversion engine 158 performs service line path finding 180 to determine service line paths, as further described with reference to FIG. 7.

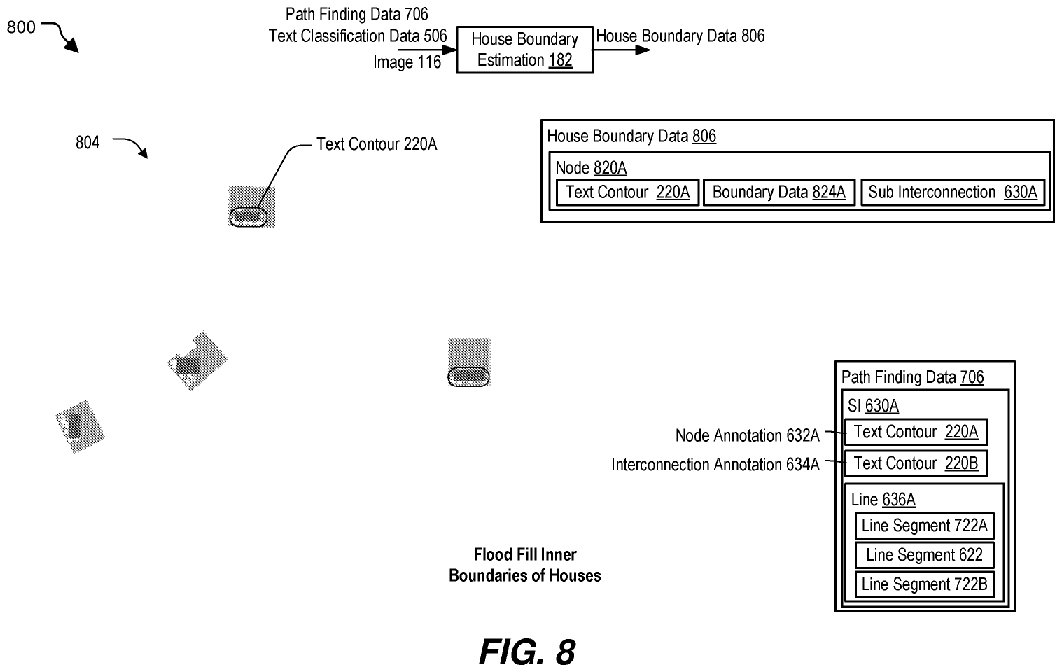

In a particular aspect, the image conversion engine 158 performs house boundary estimation 182 to determine node boundaries, as further described with reference to FIG. 8. For example, the image conversion engine 158 detects polygons representing nodes of the geographical region. A first sub interconnection may be between a first node and the main interconnection. A second sub interconnection may be between a second node and the main interconnection. The first sub interconnection, the main interconnection, and the second sub interconnection may be between the first node and the second node. In some examples, there may be one-way flow or traffic from the main interconnection to each of the first sub interconnection and the second sub interconnection. In other examples, there may be bi-directional flow or traffic via the main interconnection between the first sub interconnection and the second sub interconnection. In some examples, there may be one-way flow or traffic from each of the first sub interconnection and the second sub interconnection to the main interconnection.

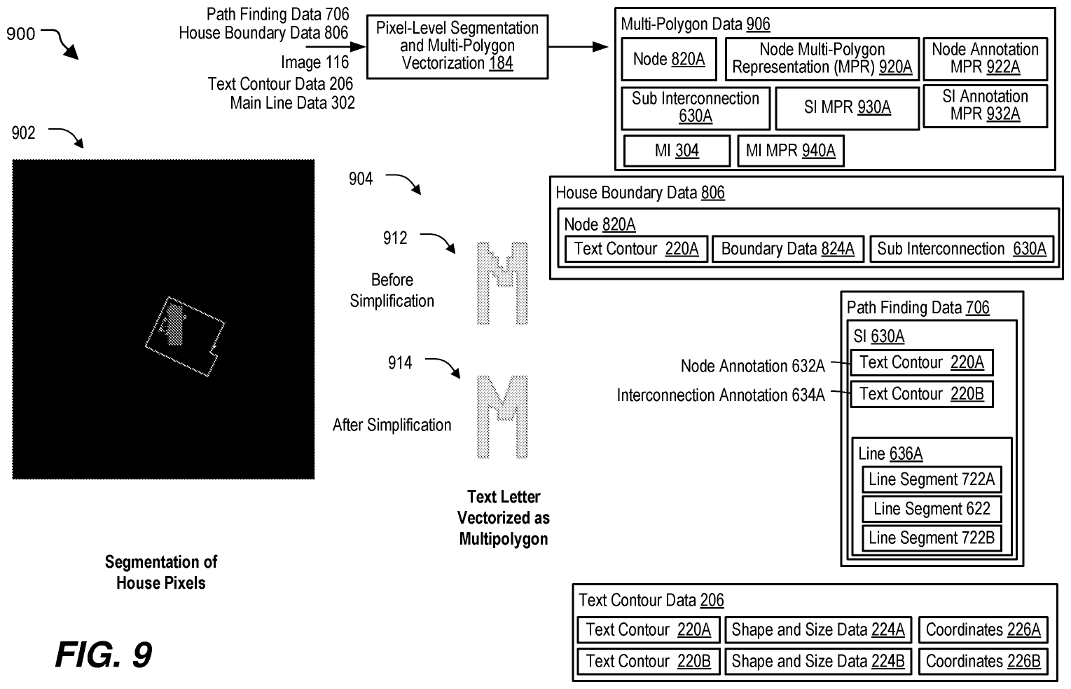

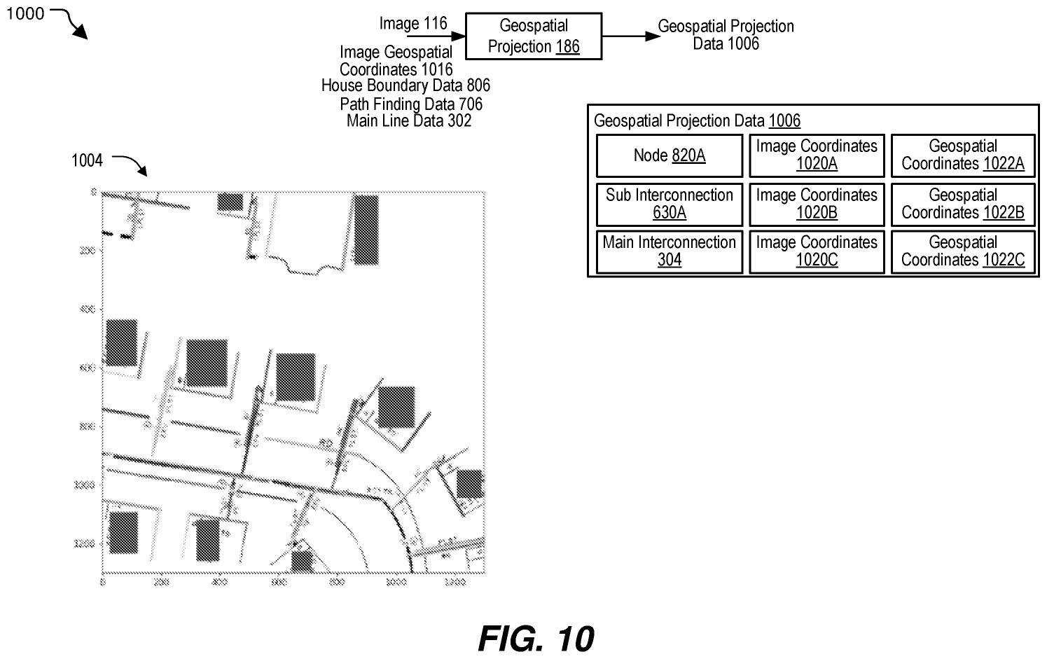

In a particular aspect, the image conversion engine 158 performs pixel-level segmentation and multi-polygon vectorization 184 to generate multi-polygon representations of the nodes, multi-polygon representations of the interconnections, multi-polygon representations of the text annotations, or a combination thereof, as further described with reference to FIG. 9. In a particular aspect, the image conversion engine 158 performs geospatial projection 186 to determine geographical coordinates associated with the nodes, the interconnections, or both, as further described with reference to FIG. 10. The image conversion engine 158 performs output generation 188 to generate the output data 118 indicating the nodes, the interconnections, the text annotations, the multi-polygon representations, the geographical coordinates, or a combination thereof. In some aspects, the image conversion engine 158 provides the output data 118 to the memory 114, the one or more other devices 144, the one or more output devices 130, or a combination thereof. In a particular aspect, the image conversion engine 158 uses one or more machine learning models to generate the output data 118. In a particular aspect, the output data 118 includes one or more vector images that correspond to at least a portion of the geographical region.

As cameras and satellite imaging have become increasingly ubiquitous, there are large sets of images available that represent geospatial data of geographical regions. The image conversion engine 158 can process the images to generate output data that includes logical representations of nodes and interconnections of the geographical regions. In some examples, the image conversion engine 158 can process the images in real-time as images are received from an image sensor to generate output data that can also be analyzed in real-time. As a non-limiting example, during a severe weather event, the output data can be analyzed to detect blockages (e.g., downed trees, flooding, etc.) in the interconnections (e.g., roads) and re-route traffic from one node to another.

Referring to FIG. 2, a diagram 200 illustrates an example of operations associated with the text contour detection 170 that may be performed by the image conversion engine 158, the one or more processors 110, the system 100 of FIG. 1, or a combination thereof, in accordance with some examples of the present disclosure.

In some aspects, the detection of nodes (e.g., houses), interconnections (e.g., utility lines), or a combination thereof, is based on detecting areas of text with a particular size, a particular shape, and particular information (e.g., particular keywords). In a non-limiting illustrative example, nodes (e.g., houses) are typically represented in the image 116 with text annotations having a first size and a first shape corresponding to multiple lines of text, and interconnections (e.g., service lines) are typically represented in the image 116 in proximity of text annotations having a second size and a second shape corresponding to a single line of text. In some aspects, text annotations for the nodes generally include first information (e.g., one or more first keywords) and text annotations for interconnections generally include second information (e.g., one or more second keywords).

The diagram 200 of FIG. 2 includes an illustrative, non-limiting, example of a text heatmap 202 corresponding to text detected in the image 116. In a particular aspect, the image conversion engine 158 uses a text detector (e.g., a high accuracy deep learning based text detector) to process the image 116 to generate the text heatmap 202. In some implementations, the image conversion engine 158 (e.g., the text detector) detects a text area by exploring each character region and affinity between characters. The text detector can process various text orientations and faded and illegible characters in a region of text. In order to detect small text in a very large image (e.g., the image 116), the image conversion engine 158 can divide the image 116 into a grid and use the text detector to process each portion of the image 116 corresponding to a cell in the grid to improve accuracy of text heatmap 202 for the whole image 116. In some examples, the image conversion engine 158 can apply a sliding window to the image 116 and portions of the image 116 corresponding to the sliding window are processed by the text detector.

In a particular aspect, an image size threshold indicates when the image 116 is to be divided into a grid prior to processing by the text detector. For example, images that are smaller than the image size threshold can be provided to the text detector as a whole. On the other hand images that are greater than or equal to the image size threshold can be divided into a grid, and a portion of the image 116 corresponding to a cell of the grid can be provided to the text detector for processing. In a particular aspect, a sliding window size can indicate how large of a portion of the image 116 is to be provided to the text detector and a sliding window shift can indicate how much and in which direction the sliding window is to move for each iteration.

In a particular aspect, the image conversion engine 158 determines whether to use a sliding window or a grid based on determining that a condition is satisfied. In some implementations, the condition, the image size threshold, the sliding window size, the sliding window shift, or a combination thereof, are based on default data, configuration settings, user input, or a combination thereof.

In some implementations, the image conversion engine 158 processes the text heatmap 202 to generate a binary image 204. The diagram 200 includes an illustrative, non-limiting, example of the binary image 204. In a particular aspect, the image conversion engine 158 generates the binary image 204 based on thresholding. For example, if the text heatmap 202 indicates a heat value of a particular pixel that is greater than or equal to a heat threshold, the binary image 204 indicates a first value (e.g., 1) for the particular pixel. Alternatively, if the text heatmap 202 indicates a heat value of the particular pixel that is less than the heat threshold, the binary image 204 indicates a second value (e.g., 0) for the particular pixel. In a particular aspect, the image conversion engine 158 applies dilation morphological operations to merge neighboring text characters into a single blob representing a patch of text.

The image conversion engine 158 applies contour detection to the binary image 204 to detect a text contour 220A, a text contour 220B, one or more additional text contours, or a combination thereof. In a particular aspect, each of the text contours 220 defines boundaries of a text blob. For example, a text contour 220 corresponds to boundaries of an area of the image 116 that includes the text blob. In FIG. 2, the contours are illustrated using a green line. The red rectangles are used to redact address information for privacy. The image conversion engine 158 generates text contour data 206 indicating the detected text contours, coordinates of the text contours in the image 116, shape and size data of each of the text contours, or a combination thereof.

In a particular aspect, coordinates of a text contour 220 in the image 116 are based on (e.g., the same as) coordinates of the text contour 220 in the binary image 204. The text contour data 206 indicates that the text contour 220A and the text contour 220B have coordinates 226A and coordinates 226B, respectively. In a particular aspect, the text contour data 206 includes shape and size data 224A and shape and size data 224B indicating a shape and size of the text contour 220A and a shape and size of the text contour 220B, respectively.

Referring to FIG. 3, a diagram 300 illustrates an example of operations associated with the main line segmentation 172 that may be performed by the image conversion engine 158, the one or more processors 110, the system 100 of FIG. 1, or a combination thereof, in accordance with some examples of the present disclosure.

In some implementations, specific types of interconnections have particular identifying features that can be used for detection when processing the image 116. As an illustrative example, a main interconnection (e.g., a main line) is represented by a thick line (e.g., greater than threshold thickness) in the image 116 (e.g., a raster image) and one or more sub interconnections (e.g., service lines) are represented by thinner lines (e.g., less than or equal to threshold thickness) and are often connected to the main interconnection.

The image conversion engine 158 segments (e.g., separates) the portions with the particular identifying features from the image 116. For example, the image conversion engine 158 generates a binary image from the image 116 and performs, on the binary image, erosion morphological operations with a particular kernel size to generate an intermediate image. Everything from the binary image is removed in the intermediate image except the thick parts (e.g., line width is greater than a threshold width). The image conversion engine 158 performs contour detection on the intermediate image to detect line contours. In an example, the image conversion engine 158 removes line contours that have a lower than threshold length from the intermediate image. The image conversion engine 158 generates main line data 302 indicating that a main interconnection 304 is represented by a line 306. The line 306 includes one or more line segments 308 corresponding to the remaining line contours in the intermediate image. In a particular aspect, the particular kernel size, the threshold width, the threshold length, or a combination thereof, are based on default data, a configuration setting, a user input, or a combination thereof.

Referring to FIG. 4, a diagram 400 illustrates an example of operations associated with the OCR 174 that may be performed by the image conversion engine 158, the one or more processors 110, the system 100 of FIG. 1, or a combination thereof, in accordance with some examples of the present disclosure.

The text contour data 206 indicates one or more text contours 220 detected in the image 116. In an example 402, the text contour data 206 indicates a text contour 220A. In an example 404, the text contour data 206 indicates a text contour 220B.

Text 424 within a text contour 220 is to be used to classify the text contour 220 as corresponding to a node annotation (e.g., a text annotation of a house), an interconnection annotation (e.g., a text annotation of a service line), or irrelevant text, as further described with reference to FIG. 5. The text 424 of the text contour 220 is also to be stored as an attribute in a vectorized object, as further described with reference to FIG. 9.

Some of the challenges faced in performing the OCR 174 can be due to arbitrary orientation of text, faded and handwritten text, extra lines and patterns around a text region, image corruption, etc. In some implementations, the image conversion engine 158 pre-processes the image 116 based on the text contour data 206 to generate one or more binary images 422, such as a binary image 422A, a binary image 422B, one or more additional binary images, or a combination thereof. The image conversion engine 158 performs the OCR 174 on the one or more binary images 422. For example, the image conversion engine 158 extracts a portion of the image 116 that corresponds to a text contour 220 as a text region image. To illustrate, the image conversion engine 158 extracts the portion of the image 116 based on the coordinates 226 and the shape and size data 224 of the text contour 220 indicated by the text contour data 206. The image conversion engine 158 applies geometric transforms, such as a perspective transformation, to scale, crop, and rotate the text region image (e.g., a bounding box of a text contour) so that the text region image corresponds to a straight vertical image of the text 424 contained in the text contour 220.

The image conversion engine 158 converts the text region image to a binary image 422 and detects contours in the binary image 422. In a particular aspect, the image conversion engine 158 removes particular contours connected to edges of the binary image 422 by updating pixel values to a background color (e.g., black in the binary image) corresponding to the particular contours. Removing the contours connected to the edges of the binary image 422 removes any extra lines and patterns. In a particular aspect, the image conversion engine 158 detects characters based on a contour size threshold and determines first coordinates (e.g., x coordinate and y coordinates) and second coordinates (e.g., x coordinate and y coordinate). In a particular aspect, the first coordinates correspond to minimum (e.g., bottom-left) coordinates of the characters and the second coordinates correspond to maximum (e.g., top-right) coordinates of the characters. The binary image 422 is cropped using the first coordinates and the second coordinates to define text bounds. The example 402 indicates the binary image 422A, and the example 404 indicates the binary image 422B.

In a particular aspect, the image conversion engine 158 processes a binary image 422 using an OCR engine (e.g., a pre-trained OCR engine) to generate text 424 indicating detected characters (e.g., letters, digits, other characters, or a combination thereof). In a particular aspect, the OCR engine uses a pre-processing pipeline and a machine learning model (e.g., an LSTM model). In a particular aspect, the OCR engine has options for setting page segmentation mode (PSM) to improve OCR accuracy with an expected arrangement of text, if known. In some implementations, the PSM 6 (single uniform block of text) and PSM 11 (sparse text, as much text as possible) are both used to get two different results and corresponding confidence levels, and the result with highest confidence level is selected as the text 424. In some examples, the correct orientation of the text 424 is one of the four 90° rotations of the binary image 422 (e.g., the straight vertical image of the text region). In some examples, the image conversion engine 158 applies the OCR 174 to binary images corresponding to all four rotations. The image conversion engine 158 can thus use OCR 174 multiple times (e.g., 8 times, for 2 modes*4 orientations) to generate multiple results and confidence levels, and a result with the highest confidence level is selected as the text 424.

In a particular aspect, the image conversion engine 158 determines whether to perform additional OCRs based on a confidence level of a previous OCR result. For example, the image conversion engine 158 performs, on a binary image 422 having a first orientation (e.g., 0 degrees), the OCR 174 corresponding to a first mode (e.g., PSM 6) to generate a result with a first confidence level. If the first confidence level is greater than a confidence threshold, the image conversion engine 158 selects the result as the text 424. Alternatively, the image conversion engine 158 performs an additional OCR 174 corresponding to a second orientation, a second mode (e.g., PSM 11), or both, to generate a second result with a second confidence. Selectively performing OCR 174 can balance improved accuracy with resource conservation.

The image conversion engine 158 generates text annotation data 406 indicating the text contour 220, the text 424, the text coordinates 426 (e.g., the first coordinates and the second coordinates) of the text 424, or a combination thereof. For example, the text annotation data 406 indicates that the text contour 220A includes the text 424A and that the text 424A has text coordinates 426A (e.g., first bottom-left coordinates and first top-right coordinates) in the image 116. As another example, the text annotation data 406 indicates that the text contour 220B includes the text 424B and that the text 424B has text coordinates 426B (e.g., second bottom-left coordinates and second top-right coordinates) in the image 116.

Referring to FIG. 5, a diagram 500 illustrates an example of operations associated with the text contour classification 176 that may be performed by the image conversion engine 158, the one or more processors 110, the system 100 of FIG. 1, or a combination thereof, in accordance with some examples of the present disclosure.

The image conversion engine 158 performs the text contour classification 176 to classify a text contour 220 as associated with a node annotation (e.g., a text annotation of a house), an interconnection annotation (e.g., a text annotation of a service line), or irrelevant text. In an example 502, the text annotation data 406 indicates a text contour 220A and a text contour 220B. In an example 504, the text annotation data 406 indicates a text contour 220C.

The image conversion engine 158 performs the text contour classification 176 using rule-based reasoning utilizing features related to the text 424 indicated by the text annotation data 406 as corresponding to a text contour 220, and features related to shape and size by shape and size data 224 of the text contour 220. The text-based features include number of letters, number of digits, number of dashes, number of lines of text, or a combination thereof. For example, the text annotation data 406 indicates that a text contour 220 includes text 424. The image conversion engine 158 determines a letter count of letters in the text 424, a character count of characters in the text 424, a digit count of digits in the text 424, a dash count of dashes in the text 424, a line count of lines in the text 424, or a combination thereof.

In some aspects, the image conversion engine 158 classifies the text contour 220 (as corresponding to a node annotation, an interconnection annotation, or irrelevant text) based at least in part on the character count, the letter count, the digit count, the dash count, the line count, or a combination thereof. For example, a single line of text can indicate an interconnection annotation, whereas multiple lines of text can indicate a node annotation. As another example, a first character count range (e.g., greater than or equal to 8 and less than or equal to 15 characters), a second character count range (e.g., greater than 15 and less than or equal to 25 characters), and a third character count range (e.g., less than 8 or more than 25 characters) can indicate an interconnection annotation, a node annotation, or irrelevant text, respectively. Similarly, particular letter count ranges, particular digit count ranges, particular dash count ranges, or a combination thereof, can indicate an interconnection annotation, a node annotation, or irrelevant text.

The text-based features can also include presence of specific character sequences. For example, one or more first character sequences (e.g., PLST, HDPE, CC, or HDPLST) can indicate an interconnection annotation (e.g., service line annotation). As another example, one or more second character sequences (e.g., starting with R-, L-, or M-) can indicate a node annotation. Similarly, one or more third character sequences (e.g., AREA, ELECTRIC, CURB, or TRENCH) can indicate irrelevant text.

In some aspects, the image conversion engine 158 classifies the text contour 220 (as corresponding to a node annotation, an interconnection annotation, or irrelevant text) based at least in part on a shape of the text contour 220, a size of the contour 220, or both. For example, a ratio of a height of the text contour 220 (e.g., a bounding box of a text region) to a width of the text contour 220 can be used for the text contour classification 176. For example, a greater than threshold difference between the height and the width can indicate a long and thin text region corresponding to an interconnection annotation. In a particular implementation, the image conversion engine 158 applies clustering (e.g., K-Means clustering with K=2) to the text contours 220 indicated by the text contour data 206 to determine a first cluster corresponding to interconnection (e.g., service line) text contours and a second cluster corresponding to node (e.g., house) text contours. In some examples, the cluster centroid values are used to determine thresholds for determining that a text contour is big (e.g., indicating a node annotation) or small (e.g., indicating an interconnection annotation). In a particular aspect, the image conversion engine 158 uses exploratory data analysis to determine a maximum node contour area threshold (e.g., a maximum house contour area threshold), a maximum interconnection contour area threshold (e.g., a maximum service line contour area threshold), or both. In some examples, the image conversion engine 158 can compare a contour area of a text contour 220 to the maximum node contour area threshold, the maximum interconnection contour area threshold, or both, to classify the text contour 220 as associated with a node annotation, an interconnection annotation, or irrelevant text.

In some implementations, the text-based features, the shape and size features, or a combination thereof, are associated with particular confidence levels, and the image conversion engine 158 selects particular features for performing the text contour classification 176 of a particular text contour 220 based on the feature information available for the text contour 220. As an illustrative example, the image conversion engine 158 can classify the text contour 220 as corresponding to a node annotation in response to determining that the text 424 of the text contour 220 includes at least one of the one or more first character sequences (e.g., PLST, HDPE, CC, or HDPLST) independently of whether the other features correspond to a node annotation. Alternatively, the image conversion engine 158 can, in response to determining that the text 424 of the text contour 220 does not include any of the first character sequences, the second character sequences, or third character sequences, rely on other feature information to classify the text contour 220.

In some implementations, the image conversion engine 158 uses a hierarchy of if-then-else rules based on the features for the text contour classification 176. With more training data, the image conversion engine 158 can be trained to use techniques such as decision trees and rule extraction methods which may lead to greater robustness and accuracy.

In a particular aspect, the image conversion engine 158 classifies the text contour 220A as corresponding to a node annotation based on text-based features of the text of the text contour 220A indicated by the text annotation data 406, the shape and size features of the text contour 220A indicated by the text contour data 206, or a combination thereof. Similarly, the image conversion engine 158 classifies the text contour 220B as corresponding to a node annotation and the text contour 220C as corresponding to an interconnection annotation. The image conversion engine 158 generates text classification data 506 indicating an annotation type 526A of the text contour 220A corresponding to a node annotation, an annotation type 526B of the text contour 220B corresponding to a node annotation, and an annotation type 526C of the text contour 220C corresponding to an interconnection annotation.

Referring to FIG. 6, a diagram 600 illustrates an example of operations associated with the line detection and ranking 178 that may be performed by the image conversion engine 158, the one or more processors 110, the system 100 of FIG. 1, or a combination thereof, in accordance with some examples of the present disclosure.

In a particular aspect, the image conversion engine 158 identifies the main interconnection, as described with reference to FIG. 3. The image conversion engine 158 performs the line detection and ranking 178 to identify one or more sub interconnections (e.g., service lines). The image conversion engine 158 performs the house boundary estimation 182 to identify node boundaries (e.g., house boundaries) for each of the text contours that are classified as node annotations (as indicated by the text classification data 506), as described with reference to FIG. 8. In some implementations, the house boundary estimation 182 can be performed prior to the line detection and ranking 178.

The image conversion engine 158 performs line detection to identify one or more sub interconnections. In a particular aspect, the image conversion engine 158 pre-processes the image 116 (e.g., a copy of the image 116) to improve line detection accuracy. For example, the image conversion engine 158 applies dilation to fill gaps between pixels. In some aspects, multiple lines can be detected corresponding to the same sub interconnection. The image conversion engine 158, in response to detecting a pair of parallel lines that are within a threshold distance of each other, removes the smaller one of the parallel lines or removes one of the parallel lines if they are of the same length.

The image conversion engine 158 determines a region of interest. The region of interest corresponds to a text contour 220A with an annotation type 526A indicating a node annotation (e.g., a house annotation). For example, the region of interest includes the text contour 220A and is of a given size. To illustrate, the region of interest includes the text contour 220A and a border of pixels that are around the text contour 220A in the image 116 (or the copy of the image 116).

In some implementations, the image conversion engine 158 applies edge detection and uses a Probabilistic Hough Transform for line detection. In some aspects, a minimum line length parameter and a maximum line gap parameter are used to detect lines while being robust to gaps and fading. For example, the minimum line length parameter and the maximum line gap parameter are used to detect lines that are likely connected to the region of interest, to detect first lines that are likely connected to second lines, or both. The detected lines may not be complete so the image conversion engine 158 extends the detected lines towards their actual ends on both sides by moving along a unit vector in the direction of an end until a pixel having a foreground color (e.g., black) is found.

Many lines in addition to those corresponding to sub interconnections (e.g., the service lines) of the node (e.g., corresponding to the text contour 220A) are present in the image 116. For example, the lines can include sides of the node, sides of other nodes, sub interconnections (e.g., service lines) of other nodes, measurement lines, other lines (e.g., roads and curb lines), or a combination thereof. In a particular aspect, the lines already selected as sub interconnections (e.g., service lines) for other nodes (e.g., houses) are drawn on a binary image and one or more lines that have not been previously selected and have end points on the previously drawn lines are added to the binary image to avoid being considered again. The image conversion engine 158 detects curb lines as very long lines in the image 116 and the curb lines are also drawn to the binary image to prevent the curb lines from being considered. In a particular aspect, the image conversion engine 158 adds one or more lines, that are indicated by the main line data 302 as corresponding to the main interconnection, to the binary image to prevent the one or more lines from being considered. In a particular aspect, the image conversion engine 158 identifies perpendicular lines in the image 116 as likely corresponding to node boundaries (e.g., walls). To illustrate, the image conversion engine 158, based on determining that a pair of lines is within a threshold distance of each other and within a threshold angle of 90 degrees from each other, identifies the pair of lines (e.g., building lines) as building lines and adds the pair of lines to the binary image to avoid the pair of lines from being considered. The image conversion engine 158 applies the binary image to a working image (e.g., the pre-processed version of the image 116) to remove the lines from the working image that are not to be considered.

Particular order of operations is described as an illustrative example, in other implementations one or more of the operations can be performed in a different order. For example, in a particular implementation, the image conversion engine 158 copies the image 116 to generate a working image. The image conversion engine 158 applies dilation to fill gaps between pixels in the working image. The image conversion engine 158, in response to detecting a pair of parallel lines that are within a threshold distance of each other, removes the smaller one of the parallel lines or removes one of the parallel lines if they are of the same length in the working image. The image conversion engine 158 removes the main lines, the curb lines, and the building lines from the working image to generate a pre-processed image. The image conversion engine 158 identifies a region of interest in the pre-processed image that includes the text contour 220 and an area around the text contour 220.

The image conversion engine 158 determines a set of candidate line segments in the region of interest as potentially corresponding to a sub interconnection for the node associated with the text contour 220A. In a particular aspect, for a line segment to be considered as a candidate line segment, the line segment should be within a threshold distance of a midpoint of the text contour 220A (e.g., house text) and the line segment should not be longer than a threshold length. In this aspect, the image conversion engine 158 removes line segments that are not within the threshold distance from a centroid 620 of the text contour 220A or are longer than the threshold length in the region of interest, the working image, the pre-processed image, the image 116, or a combination thereof.

The image conversion engine 158 ranks the remaining line segments in the region of interest based on the following Equation:

score=(Dmax−Dmin)−Kp*(Dmin)

where Dmax corresponds to a maximum distance of a candidate line segment from a centroid of a text contour 220 (e.g., a node annotation), Dmin corresponds to a minimum distance of the candidate line segment from the centroid of the text contour 220, Kp corresponds to a penalty constant (e.g., a value around 1.5). As shown in an example 602, a service line (e.g., a sub interconnection) for a house (e.g., a node) starts near house text (e.g., a node annotation) of the house, the start of the service line is at a first distance (e.g., Dmin) from the house, and an end of the service line is at a second distance (e.g., Dmax) from the house text. The Kp*(Dmin) term of the Equation penalizes line segments (e.g., by reducing the score) that are further away from the house text. The score of a line segment indicates a likelihood that the line segment corresponds to a sub interconnection of the node (e.g., a service line of the house). The image conversion engine 158 selects the line segment with the highest score as corresponding to sub interconnection of the node (e.g., the service line of the house). In an example 604, a line segment 622 has a highest score based on maximum distance and a minimum distance from the centroid 620 of the text contour 220A (e.g., a node annotation).

In a particular aspect, the text classification data 506 indicates a plurality of interconnection annotations. The image conversion engine 158 selects one of the plurality of interconnection annotations (e.g., the text contour 220B) that is closest to the line segment 622 selected as the sub interconnection (e.g., the service line), and designates the text contour 220B as an interconnection annotation associated with the sub interconnection represented by the line segment 622.

The image conversion engine 158 generates line detection data 606 indicating a sub interconnection (SI) 630A represented by a line 636A. For example, the line 636A includes at least the line segment 622. The sub interconnection 630 is associated with a node annotation 632A (e.g., the text contour 220A) and an interconnection annotation 634A (e.g., the text contour 220B). In some implementations, the line detection data 606 also indicates text 424A and text 424B included in the text contour 220A and the text contour 220B, respectively.

Referring to FIG. 7, a diagram 700 illustrates an example of operations associated with the service line path finding 180 that may be performed by the image conversion engine 158, the one or more processors 110, the system 100 of FIG. 1, or a combination thereof, in accordance with some examples of the present disclosure.

In some aspects, sub interconnections (e.g., service lines) have multiple bends and turns. A group of such contiguous line segments which are logically part of the same sub interconnection are referred to herein as a polyline. In particular aspect, the image conversion engine 158 detects a single line segment (e.g., the line segment 622) during the line detection and ranking 178, described with reference to FIG. 6. The image conversion engine 158 performs the service line path finding 180 to detect the polyline by detecting line segments on both sides of the line segment 622.

In some implementations, the image conversion engine 158 pre-processes the image 116. For example, the image conversion engine 158 generates a binary image of the image 116 and uses dilation to fill the gaps and to make lines thicker in the binary image. As another example, the image conversion engine 158 uses the text heatmap 202 to remove text portions from the binary image (or from the image 116 prior to generating the binary image) to increase accuracy of the polyline detection.

In an example 704, the image conversion engine 158 initiates analysis at a first end of the line segment 622 and scans the image 116 (or the pre-processed version of the image 116, such as the binary image) in directions of many closely-packed straight lines at different angles in a first range (e.g., −120 degrees to 120 degrees) around the first end of the line segment 622. Each of the scanning lines starts at the first end. For example, each of the one or more scanning line segments is between a first threshold angle (e.g., −120 degrees) and a second threshold angle (e.g., 120 degrees) relative to the line segment 622. One of the scanning lines (e.g., a middle scanning line) corresponds to a first angle (e.g., 0 degrees) that is in the middle of the first range and corresponds to a continuation of the line segment 622 beyond the first end in the same direction as from a second end of the line segment 622 to the first end.

In a particular aspect, the image conversion engine 158 performs the linear scanning at different angles using vector math by rotating and scaling the unit vector in a direction from start (e.g., −120 degrees) to end (e.g., 120 degrees) around the first end of the line segment 622. The number of scanning lines can be varied using a particular angle between each pair of the scanning lines. The linear step size and allowed gap length can also be varied.

The image conversion engine 158 stops scanning along a scanning line when greater than a threshold count of pixels with a background color (e.g., a black pixel in a binary image) are detected, a pixel of a line corresponding to a main interconnection (e.g., as described with reference to FIG. 3) is detected, a limit (e.g., an edge) of the image 116 (or the pre-processed version the image 116) is reached, or a max scan threshold is reached. In implementations in which the house boundary estimation 182 is performed prior to the service line path finding 180, the image conversion engine 158 can stop scanning along a scanning line if a boundary (e.g., a wall) of a node (e.g., a house) is reached.

The image conversion engine 158 selects the scanning line (e.g., a line segment 722A) that covers the most distance traveling from the first end of the line segment 622 as a next line segment of the polyline (e.g., the line 636A). A last scanned pixel of the next line segment (e.g., the line segment 722A) corresponds to a first end of the next line segment. The image conversion engine 158 initiates analysis of the first end of the next line segment (e.g., the line segment 722A), and so on, until a maximum count of line segments is reached or until scanning at an end of a line segment is stopped along all potential scanning lines from the end because scanning has reached a greater than a threshold count (e.g., greater than an allowed gap length) of background color pixels, a main interconnection pixel, or an image limit.

Similarly, the image conversion engine 158 performs analysis at the second end of the line segment 622 and scans the image 116 (or the pre-processed version of the image 116, such as the binary image) in directions of many closely-packed straight lines at different angles in a first range (e.g., −120 degrees to 120 degrees) around the second end of the line segment 622. For example, the image conversion engine 158 selects a line segment 722B and initiates analysis at an end of the line segment 722B, and so on. The selected line segments (e.g., the line segment 722A, the line segment 722B, one or more additional line segments) and the line segment 622 form the polyline (e.g., the line 636A) representing the sub interconnection 630A (e.g., a service line).

The image conversion engine 158 generates path finding data 706 indicating that the sub interconnection 630A (e.g., a service line) corresponds to the polyline including the line segment 722A, the line segment 722B, and the line segment 622. In a particular aspect, the path finding data 706 is a copy of the line detection data 606 with any selected line segments (e.g., the line segment 722A, the line segment 722B, one or more selected line segments, or a combination thereof) added to the line 636A of the sub interconnection 630A.

Referring to FIG. 8, a diagram 800 illustrates an example of operations associated with the house boundary estimation 182 that may be performed by the image conversion engine 158, the one or more processors 110, the system 100 of FIG. 1, or a combination thereof, in accordance with some examples of the present disclosure.

The image conversion engine 158 performs a node boundary estimation (e.g., the house boundary estimation 182) of a node 820 for each text contour 220 that is indicated by the text classification data 506 as a node annotation (e.g., has an annotation type 526 indicating a node annotation). For example, the image conversion engine 158, based on determining that a text contour 220 is classified as a node annotation, designates the text contour 220 as associated with a node 820 and uses the node boundary estimation to detect a particular polygon that represents the node 820.

In a first implementation, the image conversion engine 158 performs the house boundary estimation 182 using a flood fill algorithm when closed boundaries are detected around a text contour 220. In a second implementation, the image conversion engine 158 performs the house boundary estimation 182 using contour detection. In some aspects, the image conversion engine 158 uses the flood fill algorithm and determines whether the boundary around the text contour 220 corresponds to a closed boundary. The image conversion engine 158 performs contour detection in response to determining that the boundary around the text contour 220 is open.

The flood fill algorithm corresponds to a classic graph theory, machine vision, and computer graphics algorithm used in a wide range of applications, including the “bucket paint” tool used in various image editing software. The objective of the flood fill algorithm is straightforward: given a position inside a closed boundary, the algorithm fills the boundary with a given pixel value and hence segments the inside of a closed shape.

In a particular aspect, the image conversion engine 158 pre-processes the image 116 to remove most of the text 424 of the node 820 corresponding to the text contour 220. For example, the image conversion engine 158 scales down a bounding box of the text 424 in the image 116 to 90% to generate a pre-processed version of the image 116. The image conversion engine 158 generates a text heatmap of the pre-processed version of the image 116, generates a binary image from the text heatmap, and performs a bitwise operation (e.g., a bitwise AND) on the pre-processed version of the image 116 and a masking image (e.g., the binary image with a bounding box drawn on the binary image) to generate an intermediate image.

In a particular aspect, the intermediate image includes background colored pixels (e.g., white pixels) corresponding to first pixels that have the background color in the image 116 and second pixels corresponding to text that was removed using the masking image. The image conversion engine 158 performs flood filling based on a location of the text contour 220. The image conversion engine 158 generates a list of positions of the background colored pixels in the intermediate image (or in the binary image) that are around the location of the text contour 220, and selects a particular position (e.g., a middle position) from the list as a start point. The image conversion engine 158 updates the intermediate image by using the background color (e.g., white) for a flood fill beginning from the start point.

After flood filling, the image conversion engine 158 determines whether the node boundary is closed based on a percentage of filled region in the region of interest image that is used in the line detection and ranking 178, described with reference to FIG. 6. A higher than threshold percentage indicates that an area outside the node 20 (e.g., house) was filled corresponding to an open boundary.

The image conversion engine 158, in response to determining that the node boundary is open, performs contour detection, based on the location of the text contour 220, on the intermediate image to segment the node boundary. The image conversion engine 158, in response to determining that the path finding data 706 indicates that the text contour 220 corresponds to a node annotation for a sub interconnection 630, determines that the node 820 (e.g., house) is connected to the sub interconnection 630 (e.g., service line). The image conversion engine 158 removes the lines corresponding to the sub interconnection 630 to determine a contour representing the node 820 and not the sub interconnection 630. For example, the image conversion engine 158 draws the line 636A (corresponding to the polyline representing the sub interconnection 630) as a background color (e.g., black) with a greater than threshold thickness in the masking image (e.g., the inverted binary image). In a particular aspect, the image conversion engine 158 removes the line 636A from the intermediate image by applying the masking image to the intermediate image.

The image conversion engine 158 uses a contour detection algorithm on the intermedia image (e.g., with the line 636A removed) to detect contours, and selects the largest contour that is within a threshold distance from a midpoint of the text contour 220 as a main contour of the node 820. In some aspects, the image conversion engine 158 also selects one or more sub contours that are within a threshold distance of the main contour to include all parts of an open node boundary. Constraints on size and distance of the main contour and the one or more sub contours are used to prevent associating structures other than the node 820 in case of false positive node region detections. In a particular aspect, detecting the main contour and the one or more sub contours, if any, corresponds to detecting a polygon representing the node 820. If an output format requirement is to represent the nodes (e.g., houses) as simplified polygons represented by four points then a rotated bounding box of the main contour representing the node is used as that polygon.

In an example 804, the image conversion engine 158, based on the path finding data 706, generates house boundary data 806 indicating that a node 820A corresponding to the text contour 220A is connected to the sub interconnection 630A. The image conversion engine 158, based on detecting the main contour, the one or more sub contours, or a combination thereof, of the node 820A, updates the house boundary data 806 to indicate boundary data 824A of the node 820A. In a particular aspect, the boundary data 824A indicates the main contour, the one or more sub contours, or a combination thereof, of the node 820A. In a particular aspect, the boundary data 824A indicates a simplified polygon representing the main contour, the one or more sub contours, or a combination thereof.

Referring to FIG. 9, a diagram 900 illustrates an example of operations associated with the pixel-level segmentation and multi-polygon vectorization 184 that may be performed by the image conversion engine 158, the one or more processors 110, the system 100 of FIG. 1, or a combination thereof, in accordance with some examples of the present disclosure.

In a particular aspect, the image conversion engine 158 performs the pixel-level segmentation and multi-polygon vectorization 184 if detailed and low-level visual information of the written text, structure of houses, service lines, symbols, etc. is to be captured. The image conversion engine 158, for segmenting all pixels of a node 820, scales up a rotated bounding box of a node contour (e.g., indicated by the boundary data 824) of the node 820, draws the scaled up bounding box on a binary image, and applies the binary image as a mask to the image 116 to generate a node image. In a particular implementation, applying the binary image as a mask to the image 116 corresponds to performing a bit-wise operation (e.g., an AND operation) between the binary image and the image 116.

In a particular aspect, the image conversion engine 158, based on determining that the house boundary data 806 indicates that the node 820 corresponds to a text contour 220, determines a text region contour based on the shape and size data 224 and the coordinates 226 of the text contour 220 indicated by the text contour data 206. The image conversion engine 158 draws the text region contour on a binary image, and applies the binary image to the image 116 to generate a node annotation image. The diagram 900 includes an example 902 of the node image combined with the node annotation image.

In a particular aspect, the image conversion engine 158, based on determining that the house boundary data 806 indicates that the node 820 has a sub interconnection 630 and that the path finding data 706 indicates that a text contour 220 corresponds to an interconnection annotation 634 of the sub interconnection 630, determines a text region contour based on the shape and size data 224 and the coordinates 226 of the text contour 220 indicated by the text contour data 206. The image conversion engine 158 draws the text region contour on a binary image, and applies the binary image to the image 116 to generate a sub interconnection annotation image.

The image conversion engine 158, based on determining that the house boundary data 806 indicates that the node 820 has a sub interconnection 630 and that the path finding data 706 indicates that the sub interconnection 630 is represented by a polyline (e.g., the line 636), applies a sliding window along the polyline in the image 116 and extracts all foreground colored pixels (e.g., non-white pixels) in the sliding window as a sub interconnection image. In some examples, a window size of the sliding window can be varied based on a length of a particular line segment of the line 636 that is being processed using the sliding window.

In a particular implementation, the image conversion engine 158, based on determining that the main line data 302 indicates that the main interconnection 304 is represented by the line 306, applies a sliding window along the line 306 in the image 116 and extracts all foreground colored pixels (e.g., non-white pixels) in the sliding window as a main interconnection image. In some examples, a window size of the sliding window can be varied based on a length of a particular line segment of the line 306 that is being processed using the sliding window.

After the pixel level segmentation to generate the node image, the node annotation image, the sub interconnection annotation image, the sub interconnection image, the main interconnection image, or a combination thereof, the image conversion engine 158 vectorizes the images as multi-polygon objects. In a particular example, each of the node image, the node annotation image, the sub interconnection annotation image, the sub interconnection image, the main interconnection image, or a combination thereof, has background pixels of a background color (e.g., black), and the image conversion engine 158 performs raster to vector conversion of the images to generate multi-polygon representations (e.g., vector images). For example, the image conversion engine 158 performs raster to vector conversion of the node image, the node annotation image, the sub interconnection image, the sub interconnection annotation image, and the main interconnection image to generate a node multi-polygon representation (MPR) 920, a node annotation MPR 922, a sub interconnection MPR 930, a sub interconnection annotation MPR 932, a main interconnection MPR 940, respectively. In a particular aspect, the image conversion engine 158 uses Bresenham's line algorithm of the Rasterio library to generate the MPRs and the MPRs include Shapely polygons.

In a particular aspect, the image conversion engine 158 performs polygon simplification of the MPRs to reduce a count of vertices and to reduce data density and size. For example, the image conversion engine 158 uses the Douglas-Peucker algorithm to perform the polygon simplification. In an example 912, a letter of the annotation MPR (e.g., the node annotation MPR 922 or the SI annotation MPR 932) is shown prior to polygon simplification. In an example 914, the letter is shown subsequent to polygon simplification. Having the annotation MPR available for user analysis can be beneficial in some cases. For example, for illegible text, a user may be able to visually inspect the annotation MPR to determine whether the OCR 174 was performed accurately or whether the text 424 is to be updated in the text annotation data 406.

In the example shown in the diagram 900, the image conversion engine 158 generates the multi-polygon data 906 indicating a node MPR 920A and a node annotation MPR 922A of the node 820A, a sub interconnection MPR 930A and a sub interconnection annotation MPR 932A of the sub interconnection 630A, and a main interconnection MPR 940A of the main interconnection 304.

Referring to FIG. 10, a diagram 1000 illustrates an example of operations associated with the geospatial projection 186 that may be performed by the image conversion engine 158, the one or more processors 110, the system 100 of FIG. 1, or a combination thereof, in accordance with some examples of the present disclosure.

The image conversion engine 158, based on the house boundary data 806, determines image coordinates 1020A (e.g., pixel coordinates) of a node 820A indicated by the boundary data 824A of the node 820A. Similarly, the image conversion engine 158, based on the path finding data 706, determines image coordinates 1020B (e.g., pixel coordinates) of the sub interconnection 630A represented by the line 636A. The image conversion engine 158, based on the main line data 302, determines image coordinates 1020C (e.g., pixel coordinates) of the main interconnection 304 represented by the line 306.

The image conversion engine 158 obtains image geospatial coordinates 1016 of the image 116 from a geodatabase. For example, the image geospatial coordinates 1016 indicate first geospatial coordinates (e.g., a first longitude and a first latitude) corresponding to first image coordinates of a first corner (e.g., the bottom-left corner) of the image 116 and second geospatial coordinates (e.g., a second longitude and a second latitude) corresponding to second image coordinates of a second corner (e.g., the top-right corner) of the image 116.

The image conversion engine 158 determines a linear mapping between a range of image coordinates of the image 116 and a range of geospatial coordinates associated with the image 116. The image conversion engine 158 applies the linear mapping to the image coordinates 1020A to determine geospatial coordinates 1022A of the node 820A. Similarly, the image conversion engine 158 applies the linear mapping to the image coordinates 1020B to determine geospatial coordinates 1022B of the sub interconnection 630A. The image conversion engine 158 applies the linear mapping to the image coordinates 1020C to determine geospatial coordinates 1022C of the main interconnection 304.

The image conversion engine 158 generates geospatial projection data 1006 indicating the geospatial coordinates 1022A of the node 820A, the geospatial coordinates 1022B of the sub interconnection 630A, and the geospatial coordinates 1022C of the main interconnection 304. In some implementations, the geospatial projection data 1006 also indicates the image coordinates 1020A of the node 820A, the image coordinates 1020B of the sub interconnection 630A, and the image coordinates 1020C of the main interconnection 304.

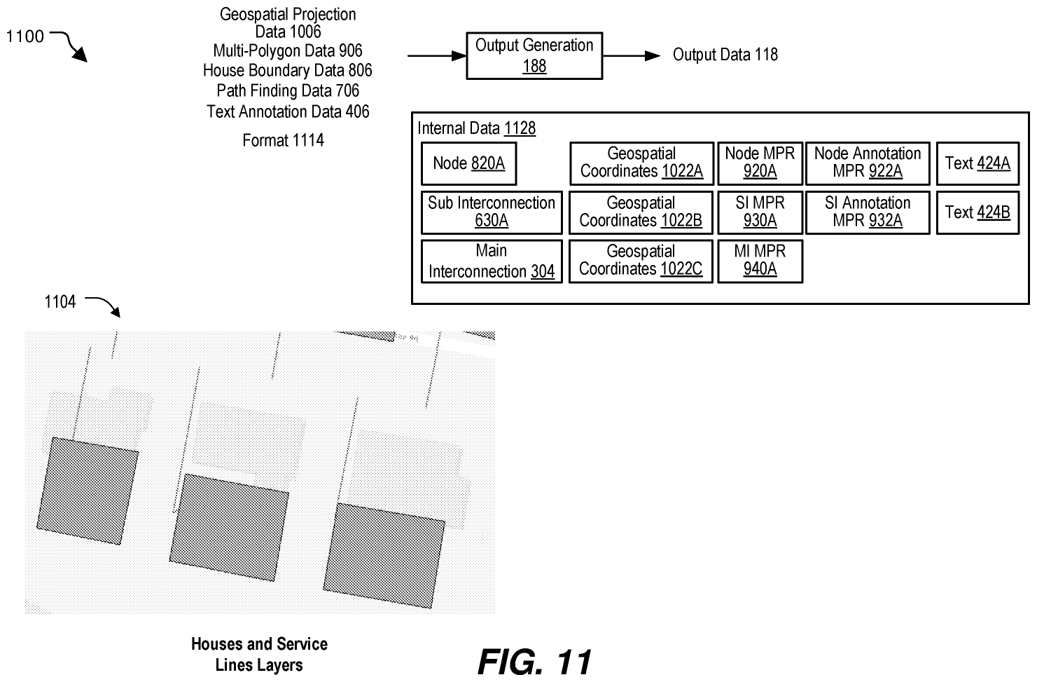

Referring to FIG. 11, a diagram 1100 illustrates an example of operations associated with the output generation 188 that may be performed by the image conversion engine 158, the one or more processors 110, the system 100 of FIG. 1, or a combination thereof, in accordance with some examples of the present disclosure.

The image conversion engine 158 generates internal data 1128 based on the text annotation data 406, the path finding data 706, the multi-polygon data 906, the geospatial projection data 1006, or a combination thereof. In a particular implementation, the image conversion engine 158, based on the geospatial projection data 1006, generates the internal data 1128 indicating the geospatial coordinates 1022A of the node 820A, the geospatial coordinates 1022B of the sub interconnection 630A, and the geospatial coordinates 1022C of the main interconnection 304. In a particular implementation, the image conversion engine 158, based on the multi-polygon data 906, generates the internal data 1128 indicating the node MPR 920A of the node 820A, the node annotation MPR 922A of a node annotation of the node 820A, the SI MPR 930A of the sub interconnection 630A, the SI annotation MPR 932A of a sub interconnection annotation of the sub interconnection 630A, the main interconnection MPR 940 of the main interconnection 304, or a combination thereof.

In a particular implementation, the image conversion engine 158, based on the house boundary data 806 indicating that the node 820A is associated with the text contour 220A and the text annotation data 406 indicating that the text contour 220A includes the text 424A, generates the internal data 1128 to indicate that a text annotation of the node 820A includes the text 424A. In a particular implementation, the image conversion engine 158, based on the path finding data 706 indicating that the interconnection annotation 634A of the sub interconnection 630A is associated with the text contour 220B and the text annotation data 406 indicating that the text contour 220B includes the text 424B, generates the internal data 1128 to indicate that a text annotation of the sub interconnection 630A includes the text 424B.

The internal data 1128 corresponds to a logical representation of nodes, interconnections, annotations, etc. In a particular aspect, the image conversion engine 158 generates the output data 118 as a copy of the internal data 1128. In an alternative aspect, the image conversion engine 158 generates, based on the internal data 1128, the output data 118 in accordance with a format 1114. In some aspects, the format 1114 is based on default data, a configuration setting, a user input, or a combination thereof.

In an example 1104, the output data 118 includes shapefiles that define layers of geometries. To illustrate, the output data 118 includes a first shapefile corresponding to a first layer that is associated with the nodes 820, a second shapefile corresponding to a second layer that is associated with the sub interconnections 630, a third shapefile corresponding to a third layer that is associated with the main interconnection 304, a fourth shapefile corresponding to a fourth layer that is associated with annotation MPRs (e.g., node annotation MPRs 922 and sub interconnection MPRs 932), or a combination thereof.

The first shapefile has a first shapefile type (e.g., POLYGON) and objects of the first shapefile type, corresponding to the nodes 820, are added to the first shapefile. For example, a first object of the first shapefile type (e.g., a polygon) corresponds to the node 820A. A position of the first object is based on the geospatial coordinates 1022A of the node 820A. In a particular aspect, fields of the first object indicate the node MPR 920A, the node annotation MPR 922A, the text 424A, or a combination thereof. A record indicating the first object, the position of the first object, the fields of the first object, or a combination thereof, is added to the first shapefile.

The second shapefile has a second shapefile type (e.g., POLYLINE) and objects of the second shapefile type, corresponding to the sub interconnections 630, are added to the second shapefile. For example, a second object of the second shapefile type (e.g., a polyline) corresponds to the sub interconnection 630A. A position of the second object is based on the geospatial coordinates 1022B of the sub interconnection 630A. In a particular aspect, fields of the second object indicate the sub interconnection MPR 930A, the sub interconnection annotation MPR 932A, the text 424B, or a combination thereof. A record indicating the second object, the position of the second object, the fields of the second object, or a combination thereof, is added to the second shapefile.

The third shapefile has a third shapefile type and an object of the third shapefile type, corresponding to the main interconnection 304, is added to the third shapefile. The third shapefile type can be the same as or distinct from the second shapefile type. In an example, a third object of the third shapefile type (e.g., a polyline) corresponds to the main interconnection 304. A position of the third object is based on the geospatial coordinates 1022C of the main interconnection 304. In a particular aspect, a field of the third object indicates the main interconnection MPR 940A. A record indicating the third object, the position of the third object, the field of the third object, or a combination thereof, is added to the third shapefile.

Objects corresponding to annotation MPRs are added to the fourth shapefile. For example, a fourth object corresponds to the node annotation MPR 922A, and a fifth object corresponds to the sub interconnection annotation MPR 932A. A first record indicating the fourth object, and a second record indicating the fifth object are added to the fourth shapefile. In an example 1104, the output data 118 corresponding to multiple shapefiles is shown. In a particular aspect, the output data 118 corresponds to one or more vector images.

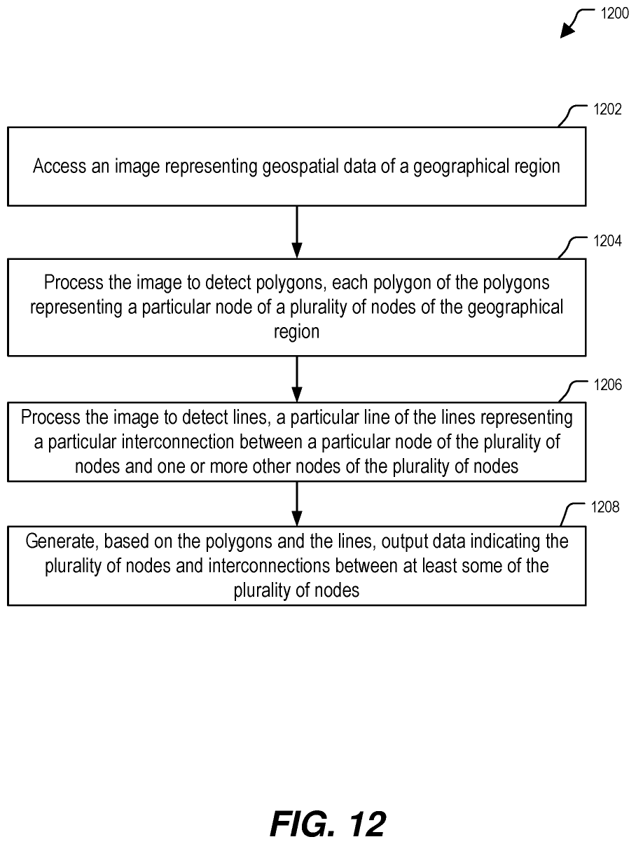

FIG. 12 is a flow chart of an example of a method 1200 in accordance with some examples of the present disclosure. One or more operations described with reference to FIG. 12 may be performed by the image conversion engine 158, the system 100 of FIG. 1, or both, such as by the one or more processors 110 executing the instructions 146.

The method 1200 includes, at 1202, accessing an image representing geospatial data of a geographical region. For example, the image conversion engine 158 accesses an image 116 representing geospatial data of a geographical region, as described with reference to FIG. 1.

The method 1200 includes, at 1204, processing the image to detect polygons. Each polygon of the polygons represents a respective node of a plurality of nodes of the geographical region. For example, the image conversion engine 158 processes the image 116 to detect polygons (e.g., multi-polygon representations). Each polygon (e.g., the node MPR 920) represents respective node (e.g., a node 820) of a plurality of nodes 820 of the geographical region, as described with reference to FIG. 9.

The method 1200 includes, at 1206, processing the image to detect lines. A particular line of the lines representing a particular interconnection between a particular node of the plurality of nodes and one or more other nodes of the plurality of nodes. For example, the image conversion engine 158 performs the main line segmentation 172, the line detection and ranking 178, and the service line path finding 180 to process the image 116 to detect lines, as described with reference to FIGS. 3, 6, and 7. The line 636 represents a sub interconnection 630 between the node 820 and the main interconnection 304, as described with reference to FIGS. 6 and 8. An interconnection between the node 820 and one or more other nodes of the nodes 820 includes the sub interconnection 630, the main interconnection 304, and one or more additional sub interconnections.

The method 1200 includes, at 1208, generating, based on the polygons and the lines, output data indicating the plurality of nodes and interconnections between at least some of the plurality of nodes. For example, the image conversion engine 158 generates, based on the polygons (e.g., indicated by the boundary data 824 of nodes 820) and lines (e.g., the line 306, the lines 636, or a combination thereof), the output data 118 indicating nodes 820 of the geographical region and interconnections (e.g., the main interconnection 304, the sub interconnections 630, or a combination thereof) between at least some of the nodes 820, as described with reference to FIG. 11.

The method 1200 thus enables processing of images to generate output data that includes logical representations of nodes and interconnections of geographical regions. In some examples, the image conversion engine 158 can process the images in real-time as images are received from an image sensor to generate output data that can also be analyzed in real-time. As a non-limiting example, during a severe weather event, the output data can be analyzed to detect blockages (e.g., downed trees, flooding, etc.) in the interconnections (e.g., roads) and re-route traffic from one node to another.

The systems and methods illustrated herein may be described in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C #, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like.

The systems and methods of the present disclosure may be embodied as a customization of an existing system, an add-on product, a processing apparatus executing upgraded software, a standalone system, a distributed system, a method, a data processing system, a device for data processing, and/or a computer program product. Accordingly, any portion of the system or a module or a decision model may take the form of a processing apparatus executing code, an internet based (e.g., cloud computing) embodiment, an entirely hardware embodiment, or an embodiment combining aspects of the internet, software and hardware. Furthermore, the system may take the form of a computer program product on a computer-readable storage medium or device having computer-readable program code (e.g., instructions) embodied or stored in the storage medium or device. Any suitable computer-readable storage medium or device may be utilized, including hard disks, CD-ROM, optical storage devices, magnetic storage devices, and/or other storage media. As used herein, a “computer-readable storage medium” or “computer-readable storage device” is not a signal.

Systems and methods may be described herein with reference to screen shots, block diagrams and flowchart illustrations of methods, apparatuses (e.g., systems), and computer media according to various aspects. It will be understood that each functional block of a block diagrams and flowchart illustration, and combinations of functional blocks in block diagrams and flowchart illustrations, respectively, can be implemented by computer program instructions.

Computer program instructions may be loaded onto a computer or other programmable data processing apparatus to produce a machine, such that the instructions that execute on the computer or other programmable data processing apparatus create means for implementing the functions specified in the flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Particular aspects of the disclosure are described below in the following Examples:

According to Example 1, a device includes: one or more processors configured to: access an image representing geospatial data of a geographical region; process the image to detect polygons, each polygon of the polygons representing a respective node of a plurality of nodes of the geographical region; process the image to detect lines, a particular line of the lines representing a particular interconnection between a particular node of the plurality of nodes and one or more other nodes of the plurality of nodes; and generate, based on the polygons and the lines, output data indicating the plurality of nodes and interconnections between at least some of the plurality of nodes.

Example 2 includes the device of Example 1, wherein the plurality of nodes represent buildings, and the interconnections represent utility lines.

Example 3 includes the device of Example 1, wherein the plurality of nodes represent buildings, and the interconnections represent roads.

Example 4 includes the device of any of Example 1 to Example 3, wherein the one or more processors are further configured to: detect a text contour corresponding to boundaries of an area of the image that includes text; perform character recognition on the area of the image to detect characters of the text; and classify the text contour as a node annotation, an interconnection annotation, or irrelevant text, wherein the text contour is classified based on the characters, a shape of the text contour, a size of the text contour, or a combination thereof.

Example 5 includes the device of Example 4, wherein the one or more processors are further configured to: based on determining that the text contour is classified as the node annotation, designate the text contour as associated with the particular node, wherein the particular node is represented by a particular polygon of the polygons; identify, based on the image, a region of interest that includes the text contour; determine a set of candidate line segments in the region of interest; and select a particular line segment from the set of candidate line segments as a sub interconnection of the particular node.

Example 6 includes the device of Example 5, wherein the one or more processors are further configured to: identify, in the image, main lines based on a greater than threshold thickness; identify, in the image, curb lines based on a greater than threshold length; identify, in the image, perpendicular lines as building lines; copy the image to generate a working image; remove the main lines, the curb lines, and the building lines from the working image to generate a pre-processed image; and identify the region of interest in the pre-processed image.

Example 7 includes the device of Example 5 or Example 6, wherein the one or more processors are further configured to, based at least in part on a distance of a line segment from the text contour, add the line segment to the set of candidate line segments.

Example 8 includes the device of any of Example 5 to Example 7, wherein the one or more processors are further configured to: determine one or more scanning line segments that starts from an endpoint of the particular line segment, each of the one or more scanning line segments is between a first angle threshold and a second angle threshold relative to the particular line segment; and select a particular scanning line segment of the one or more scanning line segments to add to the particular line.

Example 9 includes the device of any of Example 5 to Example 8, wherein the one or more processors are further configured to detect the particular polygon based on a location of the text contour.

Example 10 includes the device of Example 9, wherein the one or more processors are further configured to use a flood fill algorithm based on the location of the text contour to detect a contour of the particular polygon.

Example 11 includes the device of Example 9 or Example 10, wherein the one or more processors are further configured to, based on detecting an open boundary around the location of the text contour, use a contour detection algorithm based on the location of the text contour to detect a contour of the particular polygon.

Example 12 includes the device of any of Example 4 to Example 11, wherein the one or more processors are further configured to: apply a mask to the image to extract pixels corresponding to the text, the mask based on the text contour; and generate a representation of the pixels.

Example 13 includes the device of Example 12, wherein the one or more processors are further configured to, based on determining that the text contour is classified as associated with the node annotation, associate the representation of the pixels with the particular node.

Example 14 includes the device of Example 12, wherein the one or more processors are further configured to, based on determining that the text contour is classified as the interconnection annotation, associate the representation of the pixels with the particular interconnection.

Example 15 includes the device of any of Example 5 to Example 14, wherein the one or more processors are further configured to: apply a mask to the image to extract pixels corresponding to the particular node, the mask based on a contour of the particular polygon; generate a representation of the pixels; and associate the representation of the pixels with the particular node.

Example 16 includes the device of any of Example 1 to Example 15, wherein the one or more processors are further configured to determine geographical coordinates of the particular node based on pixel coordinates of a corresponding polygon of the polygons and geographical coordinate data of the image.

Example 17 includes the device of any of Example 1 to Example 16, wherein the one or more processors are further configured to: determine geographical coordinates of the particular interconnection based on pixel coordinates of the particular line and geographical coordinate data of the image.

According to Example 18, a method includes: accessing, at a device, an image representing geospatial data of a geographical region; processing, at the device, the image to detect polygons, a particular polygon of the polygons representing a respective node of a plurality of nodes of the geographical region; processing, at the device, the image to detect lines, a particular line of the lines representing a particular interconnection between a particular node of the plurality of nodes and one or more other nodes of the plurality of nodes; and generating, based on the polygons and the lines, output data indicating the plurality of nodes and interconnections between at least some of the plurality of nodes.

Example 19 includes the method of Example 18, wherein the plurality of nodes represent buildings, and the interconnections represent utility lines.

Example 20 includes the method of Example 18, wherein the plurality of nodes represent buildings, and the interconnections represent roads.

Example 21 includes the method of any of Example 18 to Example 20, further including: detecting a text contour corresponding to boundaries of an area of the image that includes text; performing character recognition on the area of the image to detect characters of the text; and classifying the text contour as a node annotation, an interconnection annotation, or irrelevant text, wherein the text contour is classified based on the characters, a shape of the text contour, a size of the text contour, or a combination thereof.

Example 22 includes the method of Example 21, further including: based on determining that the text contour is classified as the node annotation, designating the text contour as associated with the particular node, wherein the particular node is represented by a particular polygon of the polygons; identifying, based on the image, a region of interest that includes the text contour; determining a set of candidate line segments in the region of interest; and selecting a particular line segment from the set of candidate line segments as a sub interconnection of the particular node.

Example 23 includes the method of Example 22, further including: identifying, in the image, main lines based on a greater than threshold thickness; identifying, in the image, curb lines based on a greater than threshold length; identify, in the image, perpendicular lines as building lines; copying the image to generate a working image; removing the main lines, the curb lines, and the building lines from the working image to generate a pre-processed image; and identifying the region of interest in the pre-processed image.

Example 24 includes the method of Example 22 or Example 23, further including, based at least in part on a distance of a line segment from the text contour, adding the line segment to the set of candidate line segments.

Example 25 includes the method of any of Example 22 to Example 24, further including: determining one or more scanning line segments that starts from an endpoint of the particular line segment, each of the one or more scanning line segments is between a first angle threshold and a second angle threshold relative to the particular line segment; and selecting a particular scanning line segment of the one or more scanning line segments to add to the particular line.

Example 26 includes the method of any of Example 22 to Example 25, further including detecting the particular polygon based on a location of the text contour.

Example 27 includes the method of Example 26, further including using a flood fill algorithm based on the location of the text contour to detect a contour of the particular polygon.

Example 28 includes the method of Example 26 or Example 27, further including, based on detecting an open boundary around the location of the text contour, using a contour detection algorithm based on the location of the text contour to detect a contour of the particular polygon.

Example 29 includes the method of any of Example 21 to Example 28, further including: applying a mask to the image to extract pixels corresponding to the text, the mask based on the text contour; and generate a representation of the pixels.

Example 30 includes the method of Example 29, further including, based on determining that the text contour is classified as associated with the node annotation, associating the representation of the pixels with the particular node.

Example 31 includes the method of Example 29, further including, based on determining that the text contour is classified as the interconnection annotation, associating the representation of the pixels with the particular interconnection.

Example 32 includes the method of any of Example 22 to Example 31, further including: applying a mask to the image to extract pixels corresponding to the particular node, the mask based on a contour of the particular polygon; generating a representation of the pixels; and associating the representation of the pixels with the particular node.

Example 33 includes the method of any of Example 18 to Example 32, further including determining geographical coordinates of the particular node based on pixel coordinates of a corresponding polygon of the polygons and geographical coordinate data of the image.

Example 34 includes the method of any of Example 18 to Example 33, further including determining geographical coordinates of the particular interconnection based on pixel coordinates of the particular line and geographical coordinate data of the image.

According to Example 35, a device includes one or more processors configured to execute instructions to perform the method of any of Examples 18-34.

According to Example 36, a non-transitory computer readable medium stores instructions that are executable by one or more processors to perform the method of any of Examples 18-34.

According to Example 37, a computer-readable medium stores instructions that, when executed by one or more processors, cause the one or more processors to: access an image representing geospatial data of a geographical region; process the image to detect polygons, each polygon of the polygons representing a respective node of a plurality of nodes of the geographical region; process the image to detect lines, a particular line of the lines representing a particular interconnection between a particular node of the plurality of nodes and one or more other nodes of the plurality of nodes; and generate, based on the polygons and the lines, output data indicating the plurality of nodes and interconnections between at least some of the plurality of nodes.

Although the disclosure may include one or more methods, it is contemplated that it may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

1. A device comprising:
one or more processors configured to:
access an image representing geospatial data of a geographical region;
process the image to detect polygons, each polygon of the polygons representing a respective node of a plurality of nodes of the geographical region;
process the image to detect lines, a particular line of the lines representing a particular interconnection between a particular node of the plurality of nodes and one or more other nodes of the plurality of nodes; and
generate, based on the polygons and the lines, output data indicating the plurality of nodes and interconnections between at least some of the plurality of nodes.

2. The device of claim 1, wherein the plurality of nodes represent buildings, and the interconnections represent utility lines.

3. The device of claim 1, wherein the plurality of nodes represent buildings, and the interconnections represent roads.

4. The device of claim 1, wherein the one or more processors are further configured to:
detect a text contour corresponding to boundaries of an area of the image that includes text;
perform character recognition on the area of the image to detect characters of the text; and
classify the text contour as a node annotation, an interconnection annotation, or irrelevant text, wherein the text contour is classified based on the characters, a shape of the text contour, a size of the text contour, or a combination thereof.

5. The device of claim 4, wherein the one or more processors are further configured to:
based on determining that the text contour is classified as the node annotation, designate the text contour as associated with the particular node, wherein the particular node is represented by a particular polygon of the polygons;
identify, based on the image, a region of interest that includes the text contour;
determine a set of candidate line segments in the region of interest; and
select a particular line segment from the set of candidate line segments as a sub interconnection of the particular node.

6. The device of claim 5, wherein the one or more processors are further configured to:
identify, in the image, main lines based on a greater than threshold thickness;
identify, in the image, curb lines based on a greater than threshold length;
identify, in the image, perpendicular lines as building lines;
copy the image to generate a working image;
remove the main lines, the curb lines, and the building lines from the working image to generate a pre-processed image; and
identify the region of interest in the pre-processed image.

7. The device of claim 5, wherein the one or more processors are further configured to, based at least in part on a distance of a line segment from the text contour, add the line segment to the set of candidate line segments.

8. The device of claim 5, wherein the one or more processors are further configured to:
determine one or more scanning line segments that starts from an endpoint of the particular line segment, each of the one or more scanning line segments is between a first angle threshold and a second angle threshold relative to the particular line segment; and
select a particular scanning line segment of the one or more scanning line segments to add to the particular line.

9. The device of claim 5, wherein the one or more processors are further configured to detect the particular polygon based on a location of the text contour.

10. The device of claim 9, wherein the one or more processors are further configured to use a flood fill algorithm based on the location of the text contour to detect a contour of the particular polygon.

11. The device of claim 9, wherein the one or more processors are further configured to, based on detecting an open boundary around the location of the text contour, use a contour detection algorithm based on the location of the text contour to detect a contour of the particular polygon.

12. The device of claim 4, wherein the one or more processors are further configured to:
apply a mask to the image to extract pixels corresponding to the text, the mask based on the text contour; and
generate a representation of the pixels.

13. The device of claim 12, wherein the one or more processors are further configured to, based on determining that the text contour is classified as associated with the node annotation, associate the representation of the pixels with the particular node.

14. The device of claim 12, wherein the one or more processors are further configured to, based on determining that the text contour is classified as the interconnection annotation, associate the representation of the pixels with the particular interconnection.

15. The device of claim 5, wherein the one or more processors are further configured to:
apply a mask to the image to extract pixels corresponding to the particular node, the mask based on a contour of the particular polygon;
generate a representation of the pixels; and
associate the representation of the pixels with the particular node.

16. The device of claim 1, wherein the one or more processors are further configured to determine geographical coordinates of the particular node based on pixel coordinates of a corresponding polygon of the polygons and geographical coordinate data of the image.

17. The device of claim 1, wherein the one or more processors are further configured to determine geographical coordinates of the particular interconnection based on pixel coordinates of the particular line and geographical coordinate data of the image.

18. A method comprising:
accessing, at a device, an image representing geospatial data of a geographical region;
processing, at the device, the image to detect polygons, each polygon of the polygons representing a respective node of a plurality of nodes of the geographical region;
processing, at the device, the image to detect lines, a particular line of the lines representing a particular interconnection between a particular node of the plurality of nodes and one or more other nodes of the plurality of nodes; and
generating, based on the polygons and the lines, output data indicating the plurality of nodes and interconnections between at least some of the plurality of nodes.

19. A computer-readable medium storing instructions that, when executed by one or more processors, cause the one or more processors to:
access an image representing geospatial data of a geographical region;
process the image to detect polygons, each polygon of the polygons representing a respective node of a plurality of nodes of the geographical region;
process the image to detect lines, a particular line of the lines representing a particular interconnection between a particular node of the plurality of nodes and one or more other nodes of the plurality of nodes; and
generate, based on the polygons and the lines, output data indicating the plurality of nodes and interconnections between at least some of the plurality of nodes.

20. The computer-readable medium of claim 19, wherein the plurality of nodes represent buildings, and the interconnections represent utility lines.
